(19) United States
(12) Patent Application Publication
(10) Pub. No.: US 2026/0178350 A1
(43) Pub. Date: Jun. 25, 2026

(54) Object Graph for Concurrency Management

(71) Applicant: Oracle International Corporation, Redwood Shores, CA (US)

(72) Inventor: Erik Österlund, Vasterhaninge (SE)

(73) Assignee: Oracle International Corporation, Redwood Shores, CA (US)

(21) Appl. No.: 19/422,212

(22) Filed: Dec. 16, 2025

Related U.S. Application Data
(60) Provisional application No. 63/738,717, filed on Dec. 24, 2024.

(51) Int. Cl. G06F 9/448; G06F 9/52

(52) U.S. Cl. CPC G06F 9/449; G06F 9/52

(57) ABSTRACT

Techniques for detecting potential concurrency issues and/or causality bugs are disclosed. To this end, the system maintains at least one object graph of event objects. The event objects represent events, and the event objects in an object graph are interconnected by references that represent causal and/or temporal relationships between the corresponding events. Before a thread attempts a task that could feasibly conflict with another task, the system may compel the thread to consult the object graph. For instance, if a task entails accessing a shared object, the system may compel a thread to determine if the last event to mutate the shared object is represented in an object graph of event objects before an event corresponding to the thread's current attempt to complete this task. If the last mutation event is absent from the object graph, the system may prevent or delay the thread from completing the task.

### BENEFIT CLAIMS; RELATED APPLICATIONS; INCORPORATION BY REFERENCE

This application claims the benefit of U.S. Provisional Patent Application No. 63/738,717, filed on Dec. 24, 2024, that is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to concurrent computing architectures. In particular, the present disclosure relates to techniques for avoiding potential concurrency issues.

### BACKGROUND

With respect to a computing architecture, the term “concurrency” refers to the ability of a computing system to perform multiple tasks simultaneously and/or the ability of the computing system to perform multiple tasks in overlapping time periods. As used herein, the term “task” refers to one or more related computing operations. Performing tasks concurrently can improve the efficiency and performance of a computing system. However, concurrency can also give rise to an issue that results from one task interfering with another task being performed concurrently (referred to herein as a “concurrency issue”). Examples of concurrency issues include data races, nondeterministic behavior, memory corruption, lost updates, livelock, deadlock, resource starvation, priority inversion, thread thrashing, undefined program behavior, security risks, and others.

A concurrency issue can result from conflicting accesses to the same location in memory. For example, if two threads of execution are concurrently performing tasks that involve accessing the same shared data structure, and if one of the threads is attempting to mutate this shared data structure, a concurrency issue may arise. As used herein, the term “shared data structure” refers to a data structure accessible to multiple independent processes and/or subcomponents of processes. A runtime object is an example of a data structure that may exist in runtime memory, and a shared object (i.e., a shared runtime object) is an example of a shared data structure. The verb “mutate” refers to changing the state of a data structure, and the noun “mutator” refers to a process and/or a subcomponent of that process that is attempting to mutate a data structure. A thread of execution that writes a new value to a data structure is an example of a mutator. The term “thread of execution” is used herein to identify a subcomponent of a process. For brevity, a thread of execution may be referred to herein simply as a “thread.” Two threads that access a shared data structure in a conflicting manner may be constituents of the same process, or those two threads may be constituents of two different processes. In the example context of multiple threads collaboratively executing the same program instance, conflicting accesses to the same memory location are often the result of a causality bug in the program instance. A program may, for example, include a causality bug if a programmer fails to correctly establish or maintain the relationship between cause and effect in the logic of the program.

The approaches described in this section are approaches that could be pursued but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1 illustrates an example computing architecture in which techniques described herein may be practiced in accordance with one or more embodiments;

FIG. 2 is a block diagram illustrating a computer system suitable for implementing methods and features described herein in accordance with one or more embodiments;

FIG. 3 illustrates an example virtual machine memory layout in block diagram form in accordance with one or more embodiments;

FIG. 4 illustrates an example frame in block diagram form in accordance with one or more embodiments;

FIG. 5 illustrates a system for performing techniques described herein in accordance with one or more embodiments;

FIG. 6 illustrates an example set of operations for performing a check for potential concurrency issues in accordance with one or more embodiments;

FIGS. 7A, 7B, and 7C illustrate the impact of an example set of operations for managing concurrent computing operations in accordance with an example embodiment; and

FIG. 8 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.

The following table of contents is provided for the reader's convenience and is not intended to define the limits of the disclosure.
1. GENERAL OVERVIEW
2. ARCHITECTURAL OVERVIEW
   2.1 EXAMPLE CLASS FILE STRUCTURE
   2.2 EXAMPLE VIRTUAL MACHINE ARCHITECTURE
   2.3 LOADING, LINKING, AND INITIALIZING
3. CONCURRENCY MANAGEMENT SYSTEM
4. PERFORMING A CONCURRENCY CHECK
5. EXAMPLE EMBODIMENT
6. PRACTICAL APPLICATIONS, ADVANTAGES, AND IMPROVEMENTS
7. HARDWARE OVERVIEW
8. MISCELLANEOUS; EXTENSIONS

### 1. GENERAL OVERVIEW

One or more embodiments prevent concurrency issues by maintaining an object graph of event objects that tracks an ordering of events that occur in a concurrent computing environment. As used herein, the term “event object” refers to a runtime object that represents an event. For example, a program instance may instruct a thread to manipulate runtime objects associated with the program instance, and the system may compel the thread to create an event object that represents the thread's attempt to complete this task. To track the ordering of events, the system creates references between the corresponding event objects. In this way, the system creates an object graph of event objects. The references between the event objects in an object graph reflect causal relationships between the corresponding events and/or the temporal sequence of the corresponding events. If a thread is attempting a task that could feasibly conflict with some other task being performed concurrently, the system may compel the thread to consult an object graph of event objects to confirm if this task potentially conflicts with another task. As an example, consider a thread that is attempting to perform a task, and assume that completing the task will involve accessing a particular shared object. Since completing the task involves accessing the particular shared object, it is feasible that the task could conflict with another task being performed concurrently in this example. In particular, the task could conflict with another task that requires access to the particular shared object in this example. Before the thread is permitted to complete the task in this example, the system may compel the thread to determine if the event that last mutated the particular shared object is recorded in an object graph of event objects before an event that represents the thread's current attempt to perform the task. If the thread confirms that the last mutation event is recorded in the object graph before the current event, the system may permit the thread to complete the task in this example. On the other hand, if the last mutation event is not recorded in the object graph as having occurred before the current event in this example, this finding is indicative of a potential concurrency issue and/or a causality bug associated with the task. If there is a potential concurrency issue and/or causality bug associated with the task in this example, the system may compel the thread to abort or delay the current attempt to complete the task, flag the causality bug, and/or perform other corrective actions.

One or more embodiments prevent concurrency issues by maintaining an object graph of event objects that tracks a happens-before ordering of events that occur in a concurrent computing environment. A “happens-before ordering” refers to a relation among events where at least some pairs of events are ordered with respect to causal dependency. Based on the happens-before ordering of events recorded by the object graph of event objects, the system can identify causal inconsistencies between events even where those causal inconsistencies do not necessarily coincide with the manifestation of a concurrency issue. In an example, the system may compel any given thread to maintain a reference to an event object representing the latest event observed by that thread. Furthermore, in this example, the system may dictate that any given shared object holds a reference to the event object representing a last event to mutate that shared object. Before a thread is allowed to manipulate a particular shared object in this example, the system may compel the thread to identify the last event to mutate the particular shared object based on one such reference that (a) is maintained by the particular shared object and (b) points to an event object that represents the last mutation event. Having identified the last mutation event in this example, the system may further compel the thread to traverse an object graph of event objects to determine if this last mutation event happened before the latest event observed by the thread. In this example, the program thread initiates the traversal of the object graph by traversing the reference maintained by the thread that points to an event object representing the latest event observed by the thread. The thread may continue traversing the object graph in this example until (a) confirming the presence, within the object graph, of the event object representing the last mutation event or (b) reaching the end of the object graph. If the thread confirms the presence of the event object representing the last mutation event for the particular shared object, the system may permit the thread to manipulate the particular shared object in this example. On the other hand, if the thread is unable to find this event object in the object graph in this example, this finding would be indicative of a causal inconsistency between events that could potentially result in a concurrency issue, and the system may compel the thread to abort or delay the thread's attempt to manipulate the particular shared object, flag the causal inconsistency, and/or perform other corrective actions.

One or more embodiments prevent concurrency issues by maintaining an object graph of event objects that tracks a partial ordering of events that occur in a concurrent computing environment. A “partial ordering” refers to a happens-before ordering of a subset of events. For example, the system may generate event objects to represent events that could potentially conflict with other events in a manner that causes a concurrency issue, and the system may abstain from creating event objects to represent other events that pose no risk of a concurrency issue. Accordingly, an object graph made up of these event objects will track a partial ordering of events in this example. By tracking a partial ordering of events, an object graph of event objects may serve as a means for detecting potential concurrency issues and/or causality bugs in a cost efficient manner with respect to memory and/or processing resources.

One or more embodiments reduce the cost of detecting potential concurrency issues and/or causality bugs using an object graph of event objects by caching the results of traversals of the object graph. For instance, after a thread traverses an object graph of event objects, the system may cache the result of this traversal in an event object within the object graph and/or another memory location. Caching the result of an earlier traversal of an object graph of event objects may reduce the cost of a later traversal of the object graph. As an example, consider a traversal of an object graph of event objects seeking to confirm the presence of a particular event object in the object graph, and assume that the particular event object is, in fact, present somewhere in the object graph. Instead of traversing the object graph until arriving at the memory location of the particular event object in this example, a thread may cease this traversal upon arriving at the memory location of a subsequent (i.e., more recent) event object that caches the result of an earlier traversal that also sought to confirm the presence of the particular event object. Since the thread is able to confirm the presence of the particular event object based on the cached outcome of the prior traversal in this example, the thread does not need to repeat work that was already performed during the prior traversal. In this way, the cost of checking for potential concurrency issues and/or causality bugs by performing the subsequent traversal is reduced in this example.

One or more embodiments described in this Specification and/or recited in the claims may not be included in this General Overview section.

### 2. ARCHITECTURAL OVERVIEW

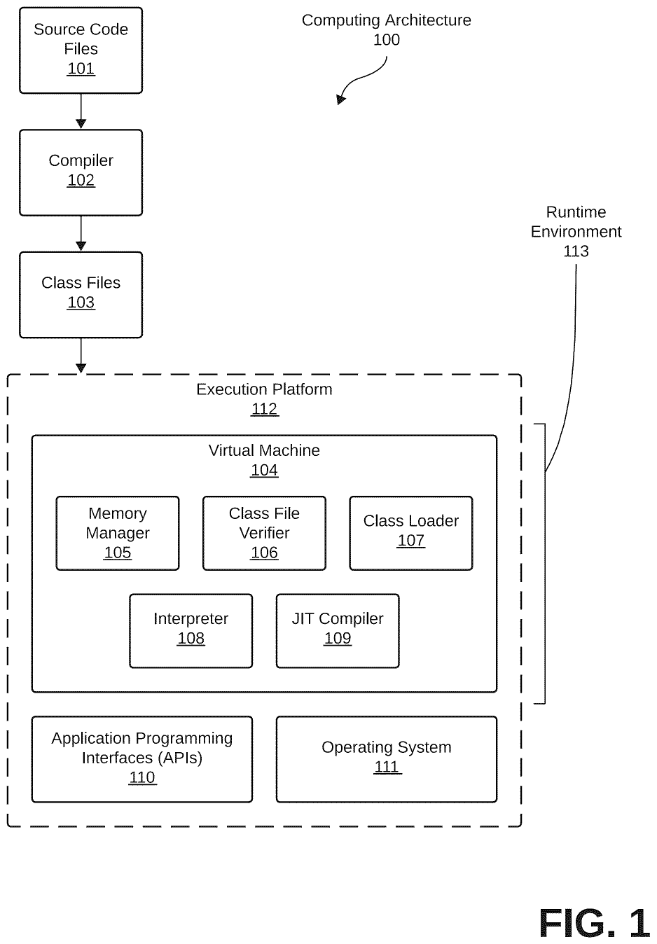

FIG. 1 illustrates an example architecture in which techniques described herein may be practiced. Software and/or hardware components described with relation to the example architecture may be omitted or associated with a different set of functionality than described herein. Software and/or hardware components, not described herein, may be used within an environment in accordance with one or more embodiments. Accordingly, the example environment should not be constructed as limiting the scope of any of the claims.

As illustrated in FIG. 1, a computing architecture 100 includes source code files 101 which are compiled by a compiler 102 into class files 103 representing the program to be executed. The class files 103 are then loaded and executed by an execution platform 112, which includes a runtime environment 113, an operating system 111, and one or more application programming interfaces (APIs) 110 that enable communication between the runtime environment 113 and the operating system 111. The runtime environment 113 includes a virtual machine 104 comprising various components, such as a memory manager 105 (which may include a garbage collector), a class file verifier 106 to check the validity of class files 103, a class loader 107 to locate and build in-memory representations of classes, an interpreter 108 for executing the virtual machine 104 code, and a just-in-time (JIT) compiler 109 for producing optimized machine-level code.

In an embodiment, the computing architecture 100 includes source code files 101 that include code that has been written in a particular programming language, such as Java, C, C++, C#, Ruby, Perl, etc. Thus, the source code files 101 adhere to a particular set of syntactic and/or semantic rules for the associated language. For example, code written in Java adheres to the Java Language Specification. However, since specifications are updated and revised over time, the source code files 101 may be associated with a version number indicating the revision of the specification to which the source code files 101 adhere. The exact programming language used to write the source code files 101 is generally not critical.

In various embodiments, the compiler 102 converts the source code, which is written according to a specification directed to the convenience of the programmer, to either machine or object code, which is executable directly by the particular machine environment, or an intermediate representation (“virtual machine code/instructions”), such as bytecode, which is executable by a virtual machine 104 that is capable of running on top of a variety of particular machine environments. The virtual machine instructions are executable by the virtual machine 104 in a more direct and efficient manner than the source code. Converting source code to virtual machine instructions includes mapping source code functionality from the language to virtual machine functionality that utilizes underlying resources, such as data structures. Often, functionality that is presented in simple terms via source code by the programmer is converted into more complex steps that map more directly to the instruction set supported by the underlying hardware on which the virtual machine 104 resides.

In general, programs are executed either as a compiled or an interpreted program. When a program is compiled, the code is transformed globally from a first language to a second language before execution. Since the work of transforming the code is performed ahead of time; compiled code tends to have excellent run-time performance. In addition, since the transformation occurs globally before execution, the code can be analyzed and optimized using techniques such as constant folding, dead code elimination, inlining, etc. However, depending on the program being executed, the startup time can be significant. In addition, inserting new code would require the program to be taken offline, re-compiled, and re-executed. For many dynamic languages (such as Java) which are designed to allow code to be inserted during the program's execution, a purely compiled approach may be inappropriate. When a program is interpreted, the code of the program is read line-by-line and converted to machine-level instructions while the program is executing. As a result, the program has a short startup time (can begin executing almost immediately), but the run-time performance is diminished by performing the transformation at runtime. Furthermore, since various instructions are analyzed individually, many optimizations that rely on a more global analysis of the program cannot be performed.

In some embodiments, the virtual machine 104 includes an interpreter 108 and a JIT compiler 109 (or a component implementing aspects of both), and executes programs using a combination of interpreted and compiled techniques. For example, the virtual machine 104 may initially begin by interpreting the virtual machine instructions representing the program via the interpreter 108 while tracking statistics related to program behavior, such as how often different sections or blocks of code are executed by the virtual machine 104. Once a block of code surpasses a threshold (is “hot”), the virtual machine 104 invokes the JIT compiler 109 to perform an analysis of the block and generate optimized machine-level instructions which replaces the “hot” block of code for future executions. Since programs tend to spend most time executing a small portion of overall code, compiling just the “hot” portions of the program can provide similar performance to fully compiled code, but without the start-up penalty. Furthermore, although the optimization analysis is constrained to the “hot” block being replaced, there still exists far greater optimization potential than converting instructions individually. There are several variations on the above described example, such as tiered compiling.

In order to provide clear examples, the source code files 101 have been illustrated as the “top level” representation of the program to be executed by the execution platform 112. Although the computing architecture 100 depicts the source code files 101 as a “top level” program representation, in other embodiments the source code files 101 may be an intermediate representation received via a “higher level” compiler that processed code files in a different language into the language of the source code files 101. Some examples in the following disclosure assume that the source code files 101 adhere to a class-based object-oriented programming language. However, this is not a requirement to utilizing the features described herein.

In an embodiment, compiler 102 receives as input the source code files 101 and converts the source code files 101 into class files 103 that are in a format expected by the virtual machine 104. For example, in the context of the JVM, the Java Virtual Machine Specification defines a particular class file format to which the class files 103 are expected to adhere. In some embodiments, the class files 103 include the virtual machine instructions that have been converted from the source code files 101. However, in other embodiments, the class files 103 may include other structures as well, such as tables identifying constant values and/or metadata related to various structures (classes, fields, methods, etc.).

The following discussion assumes that the class files 103 represents a respective “class” defined in the source code files 101 (or dynamically generated by the compiler 102/virtual machine 104). However, the aforementioned assumption is not a strict requirement and will depend on the implementation of the virtual machine 104. Thus, the techniques described herein may still be performed regardless of the exact format of the class files 103. In some embodiments, the class files 103 are divided into one or more “libraries” or “packages,” each of which includes a collection of classes that provide related functionality. For example, a library may include one or more class files that implement input/output (I/O) operations, mathematics tools, cryptographic techniques, graphics utilities, etc. Further, some classes (or fields/methods within those classes) may include access restrictions that limit their use to within a particular class/library/package or to classes with appropriate permissions.

### 2.1 Example Class File Structure

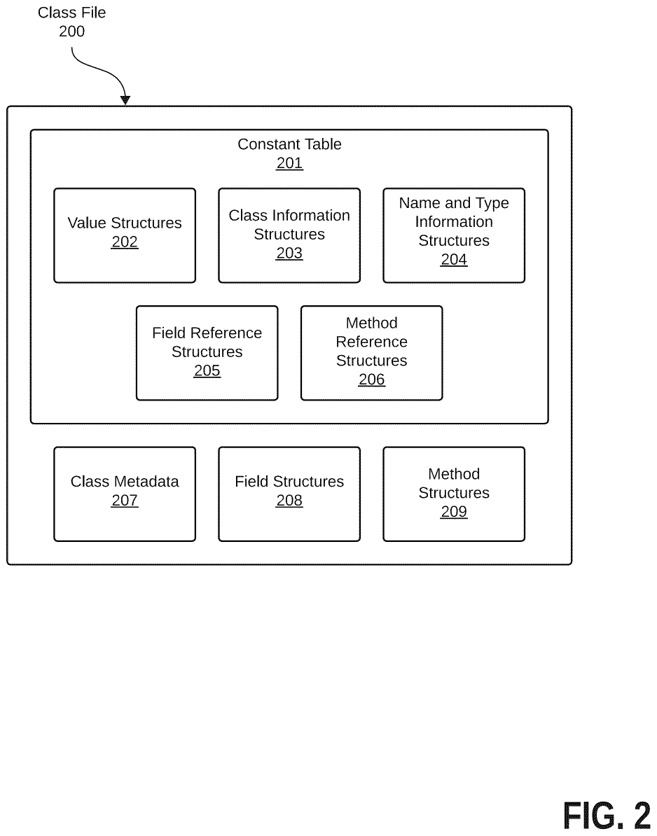

FIG. 2 illustrates an example structure for a class file 200 in block diagram form according to an embodiment. In order to provide clear examples, the remainder of the disclosure assumes that the class files 103 of the computing architecture 100 adhere to the structure of the example class file 200 described in this section. However, in a practical environment, the structure of the class file 200 will be dependent on the implementation of the virtual machine 104. Further, one or more features discussed herein may modify the structure of the class file 200 to, for example, add additional structure types. Therefore, the exact structure of the class file 200 is not critical to the techniques described herein. For the purposes of Section 2.1, “the class” or “the present class” refers to the class represented by the class file 200.

In FIG. 2, the class file 200 includes a constant table 201, class metadata 207, field structures 208, and method structures 209. In an embodiment, the constant table 201 is a data structure which, among other functions, acts as a symbol table for the class. For example, the constant table 201 may store data related to the various identifiers used in the source code files 101 such as type, scope, contents, and/or location. The constant table 201 has entries for value structures 202 (representing constant values of type int, long, double, float, byte, string, etc.), class information structures 203, name and type information structures 204, field reference structures 205, and method reference structures 206 derived from the source code files 101 by the compiler 102. In an embodiment, the constant table 201 is implemented as an array that maps an index i to structure j. However, the exact implementation of the constant table 201 is not critical.

In some embodiments, the entries of the constant table 201 include structures which index other constant table 201 entries. For example, an entry for one of the value structures 202 representing a string may hold a tag identifying its “type” as string and an index to one or more other value structures 202 of the constant table 201 storing char, byte or int values representing the ASCII characters of the string.

In an embodiment, field reference structures 205 of the constant table 201 hold an index into the constant table 201 to one of the class information structures 203 representing the class defining the field and an index into the constant table 201 to one of the name and type information structures 204 that provides the name and descriptor of the field. Method reference structures 206 of the constant table 201 hold an index into the constant table 201 to one of the class information structures 203 representing the class defining the method and an index into the constant table 201 to one of the name and type information structures 204 that provides the name and descriptor for the method. The class information structures 203 hold an index into the constant table 201 to one of the value structures 202 holding the name of the associated class.

The name and type information structures 204 hold an index into the constant table 201 to one of the value structures 202 storing the name of the field/method and an index into the constant table 201 to one of the value structures 202 storing the descriptor.

In an embodiment, class metadata 207 includes metadata for the class, such as version number(s), number of entries in the constant pool, number of fields, number of methods, access flags (if the class is public, private, final, abstract, etc.), an index to one of the class information structures 203 of the constant table 201 that identifies the present class, an index to one of the class information structures 203 of the constant table 201 that identifies the superclass (if any), etc.

In an embodiment, the field structures 208 represent a set of structures that identifies the various fields of the class. The field structures 208 store, for a field of the class, accessor flags for the field (if the field is static, public, private, final, etc.), an index into the constant table 201 to one of the value structures 202 that holds the name of the field, and an index into the constant table 201 to one of the value structures 202 that holds a descriptor of the field.

In an embodiment, the method structures 209 represent a set of structures that identifies the various methods of the class. The method structures 209 store, for a method of the class, accessor flags for the method (e.g. if the method is static, public, private, synchronized, etc.), an index into the constant table 201 to one of the value structures 202 that holds the name of the method, an index into the constant table 201 to one of the value structures 202 that holds the descriptor of the method, and the virtual machine instructions that correspond to the body of the method as defined in the source code files 101.

In an embodiment, a descriptor represents a type of a field or method. For example, the descriptor may be implemented as a string adhering to a particular syntax. While the exact syntax is not critical, a few examples are described below.

In an example where the descriptor represents a type of the field, the descriptor identifies the type of data held by the field. In an embodiment, a field can hold a basic type, an object, or an array. When a field holds a basic type, the descriptor is a string that identifies the basic type (e.g., “B”=byte, “C”=char, “D”=double, “F”=float, “I”=int, “J”=long int, etc.). When a field holds an object, the descriptor is a string that identifies the class name of the object (e.g., “L ClassName”). “L” in this case indicates a reference; thus, “L ClassName” represents a reference to an object of class ClassName. When the field is an array, the descriptor identifies the type held by the array. For example, “[B” indicates an array of bytes, with “[” indicating an array and “B” indicating that the array holds the basic type of byte. However, since arrays can be nested, the descriptor for an array may also indicate the nesting. For example, “[L ClassName” indicates an array where an index holds an array that holds objects of class ClassName. In some embodiments, the ClassName is fully qualified and includes the simple name of the class, as well as the pathname of the class. For example, the ClassName may indicate where the file is stored in the package, library, or file system hosting the class file 200.

In the case of a method, the descriptor identifies the parameters of the method and the return type of the method. For example, a method descriptor may follow the general form “({ParameterDescriptor}) ReturnDescriptor”, where the {ParameterDescriptor} is a list of field descriptors representing the parameters and the ReturnDescriptor is a field descriptor identifying the return type. For instance, the string “V” may be used to represent the void return type. Thus, a method defined in the source code files 101 as “Object m (int I, double d, Thread t) { . . . }” matches the descriptor “(I D L Thread) L Object”.

In an embodiment, the virtual machine instructions held in the method structures 209 include operations which reference entries of the constant table 201. Using Java as an example, consider the following class:
class A
{
   int add12and13 ( ) {
      return B. addTwo (12, 13);
   }
}

In the above example, the Java method add12and13 is defined in class A, takes no parameters, and returns an integer. The body of method add12 and13 calls static method addTwo of class B which takes the constant integer values 12 and 13 as parameters, and returns the result. Thus, in the constant table 201, the compiler 102 includes, among other entries, a method reference structure that corresponds to the call to the method B.addTwo. In Java, a call to a method compiles down to an invoke command in the bytecode of the JVM (in this case invokestatic as addTwo is a static method of class B). The invoke command is provided an index into the constant table 201 corresponding to the method reference structure that identifies the class defining addTwo “B”, the name of addTwo “addTwo”, and the descriptor of addTwo “(I I) I”. For example, assuming the aforementioned method reference is stored at index 4, the bytecode instruction may appear as “invokestatic #4”.

Since the constant table 201 refers to classes, methods, and fields symbolically with structures carrying identifying information, rather than direct references to a memory location, the entries of the constant table 201 are referred to as “symbolic references.” One reason that symbolic references are utilized for the class files 103 is because, in some embodiments, the compiler 102 is unaware of how and where the classes will be stored once loaded into the runtime environment 113. As will be described in Section 2.3, eventually the run-time representations of the symbolic references are resolved into actual memory addresses by the virtual machine 104 after the referenced classes (and associated structures) have been loaded into the runtime environment and allocated concrete memory locations.

### 2.2 Example Virtual Machine Architecture

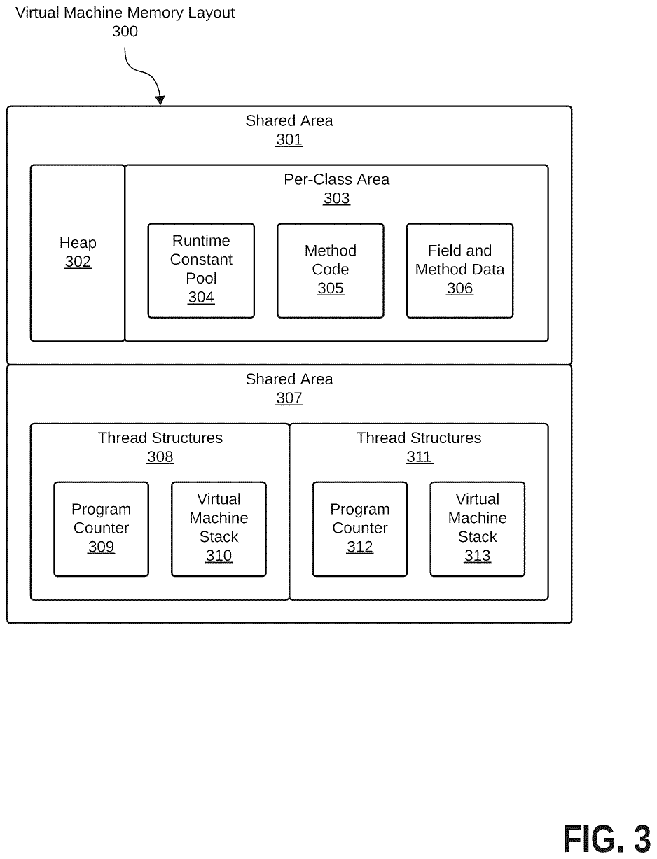

FIG. 3 illustrates an example virtual machine memory layout 300 in block diagram form according to an embodiment. In order to provide clear examples, the remaining discussion will assume that the virtual machine 104 adheres to the virtual machine memory layout 300 depicted in FIG. 3. In addition, although components of the virtual machine memory layout 300 may be referred to as memory “areas,” there is no requirement that the memory areas are contiguous.

In the example illustrated by FIG. 3, the virtual machine memory layout 300 is divided into a shared area 301 and a thread area 307. The shared area 301 represents an area in memory where structures shared among the various threads executing on the virtual machine 104 are stored. The shared area 301 includes a heap 302 and a per-class area 303. In an embodiment, the heap 302 represents the run-time data area from which memory for class instances and arrays is allocated. In an embodiment, the per-class area 303 represents the memory area where the data pertaining to the individual classes are stored. In an embodiment, the per-class area 303 includes, for a loaded class, a run-time constant pool 304 representing data from the constant table 201 of the class, field and method data 306 (for example, to hold the static fields of the class), and the method code 305 representing the virtual machine instructions for methods of the class.

The thread area 307 represents a memory area where structures specific to individual threads are stored. In FIG. 3, the thread area 307 includes thread structures 308 and thread structures 311, representing the per-thread structures utilized by different threads. In order to provide clear examples, the thread area 307 depicted in FIG. 3 assumes two threads are executing on the virtual machine 104. However, in a practical environment, the virtual machine 104 may execute any arbitrary number of threads, with the number of thread structures scaled accordingly.

In an embodiment, thread structures 308 includes program counter 309 and virtual machine stack 310. Similarly, thread structures 311 includes program counter 312 and virtual machine stack 313. In an embodiment, program counter 309 and program counter 312 store the current address of the virtual machine instruction being executed by their respective threads.

Thus, as a thread steps through the instructions, the program counters are updated to maintain an index to the current instruction. In an embodiment, virtual machine stack 310 and virtual machine stack 313 store frames for their respective threads that hold local variables and partial results, and is also used for method invocation and return.

In an embodiment, a frame is a data structure used to store data and partial results, return values for methods, and perform dynamic linking. A new frame is created each time a method is invoked. A frame is destroyed when the method that caused the frame to be generated completes. Thus, when a thread performs a method invocation, the virtual machine 104 generates a new frame and pushes that frame onto the virtual machine stack associated with the thread.

When the method invocation completes, the virtual machine 104 passes back the result of the method invocation to the previous frame and pops the current frame off of the stack. In an embodiment, for a given thread, one frame is active at any point. This active frame is referred to as the current frame, the method that caused generation of the current frame is referred to as the current method, and the class to which the current method belongs is referred to as the current class.

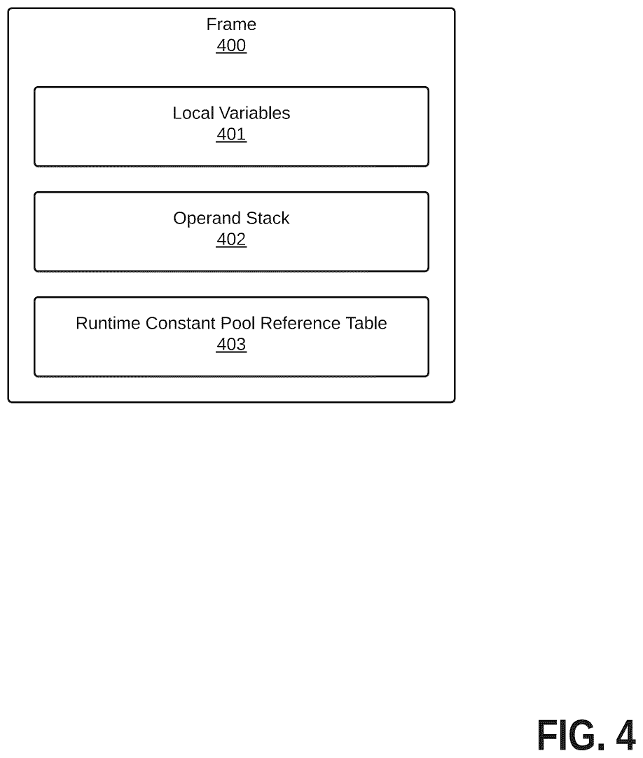

FIG. 4 illustrates an example frame 400 in block diagram form according to an embodiment. In order to provide clear examples, the remaining discussion will assume that frames of virtual machine stack 310 and virtual machine stack 313 adhere to the structure of frame 400.

In an embodiment, frame 400 includes local variables 401, operand stack 402, and run-time constant pool reference table 403. In an embodiment, the local variables 401 are represented as an array of variables that each hold a value, for example, Boolean, byte, char, short, int, float, or reference. Further, some value types, such as longs or doubles, may be represented by more than one entry in the array. The local variables 401 are used to pass parameters on method invocations and store partial results. For example, when generating the frame 400 in response to invoking a method, the parameters may be stored in predefined positions within the local variables 401, such as indexes 1-N corresponding to the first to Nth parameters in the invocation.

In an embodiment, when the frame 400 is created by the virtual machine 104, the operand stack 402 is empty by default. The virtual machine 104 then supplies instructions from the method code 305 of the current method to load constants or values from the local variables 401 onto the operand stack 402. Other instructions take operands from the operand stack 402, operate on them, and push the result back onto the operand stack 402. Furthermore, the operand stack 402 is used to prepare parameters to be passed to methods and to receive method results. For example, the parameters of the method being invoked could be pushed onto the operand stack 402 prior to issuing the invocation to the method. The virtual machine 104 then generates a new frame for the method invocation where the operands on the operand stack 402 of the previous frame are popped and loaded into the local variables 401 of the new frame. When the invoked method terminates, the new frame is popped from the virtual machine stack and the return value is pushed onto the operand stack 402 of the previous frame.

In an embodiment, the run-time constant pool reference table 403 includes a reference to the run-time constant pool 304 of the current class. The run-time constant pool reference table 403 is used to support resolution. Resolution is the process whereby symbolic references in the constant pool 304 are translated into concrete memory addresses, loading classes as necessary to resolve as-yet-undefined symbols and translating variable accesses into appropriate offsets into storage structures associated with the run-time location of these variables.

### 2.3 Loading, Linking, and Initializing

In an embodiment, the virtual machine 104 dynamically loads, links, and initializes classes. Loading is the process of finding a class with a particular name and creating a representation from the associated class file 200 of that class within the memory of the runtime environment 113. For example, creating the representation from the associated class file 200 may include creating the run-time constant pool 304, method code 305, and field and method data 306 for the class within the per-class area 303 of the virtual machine memory layout 300. Linking is the process of taking the in-memory representation of the class and combining it with the run-time state of the virtual machine 104 so that the methods of the class can be executed. Initialization is the process of executing the class constructors to set the starting state of the field and method data 306 of the class and/or create class instances on the heap 302 for the initialized class.

The following are examples of loading, linking, and initializing techniques that may be implemented by the virtual machine 104. However, in many embodiments the steps may be interleaved, such that an initial class is loaded, then during linking a second class is loaded to resolve a symbolic reference found in the first class, which in turn causes a third class to be loaded, etc. Thus, progress through the stages of loading, linking, and initializing can differ from class to class. Furthermore, some embodiments may delay (perform “lazily”) one or more functions of the loading, linking, and initializing process until the class is required. For example, resolution of a method reference may be delayed until a virtual machine instruction invoking the method is executed. Thus, the exact timing of when the steps are performed for each class can vary greatly between implementations.

To begin the loading process, the virtual machine 104 invokes the class loader 107 which loads an initial class. The technique by which the initial class is specified will vary from embodiment to embodiment. For example, one technique may have the virtual machine 104 accept a command line argument on startup that specifies the initial class.

To load a class, the class loader 107 parses the class file 200 corresponding to the class and determines if the class file 200 is well-formed (meets the syntactic expectations of the virtual machine 104). If not, the class loader 107 generates an error. For example, in Java the error might be generated in the form of an exception which is thrown to an exception handler for processing. Otherwise, the class loader 107 generates the in-memory representation of the class by allocating the run-time constant pool 304, method code 305, and field and method data 306 for the class within the per-class area 303.

In some embodiments, when the class loader 107 loads a class, the class loader 107 also recursively loads the super-classes of the loaded class. For example, the virtual machine 104 may ensure that the super-classes of a particular class are loaded, linked, and/or initialized before proceeding with the loading, linking and initializing process for the particular class.

During linking, the virtual machine 104 verifies the class, prepares the class, and resolves the symbolic references defined in the run-time constant pool 304 of the class.

To verify the class, the virtual machine 104 checks if the in-memory representation of the class is structurally correct. For example, the virtual machine 104 may check that each class except the generic class Object has a superclass, check that final classes have no sub-classes and final methods are not overridden, check if constant pool entries are consistent with one another, check if the current class has correct access permissions for classes/fields/structures referenced in the constant pool 304, check that the virtual machine 104 code of methods will not cause unexpected behavior (e.g. making sure a jump instruction does not send the virtual machine 104 beyond the end of the method), etc. The exact checks performed during verification are dependent on the implementation of the virtual machine 104. In some cases, verification may cause additional classes to be loaded, but does not necessarily require those classes to also be linked before proceeding. For example, assume Class A includes a reference to a static field of Class B. During verification, the virtual machine 104 may check Class B to ensure that the referenced static field actually exists, which might cause loading of Class B, but not necessarily the linking or initializing of Class B. However, in some embodiments, certain verification checks can be delayed until a later phase, such as being checked during resolution of the symbolic references. For example, some embodiments may delay checking the access permissions for symbolic references until those references are being resolved.

To prepare a class, the virtual machine 104 initializes static fields located within the field and method data 306 for the class to default values. In some cases, setting the static fields to default values may not be the same as running a constructor for the class. For example, the verification process may zero out or set the static fields to values that the constructor would expect those fields to have during initialization.

During resolution, the virtual machine 104 dynamically determines concrete memory address from the symbolic references included in the run-time constant pool 304 of the class. To resolve the symbolic references, the virtual machine 104 utilizes the class loader 107 to load the class identified in the symbolic reference (if not already loaded). Once loaded, the virtual machine 104 has knowledge of the memory location within the per-class area 303 of the referenced class and its fields/methods. The virtual machine 104 then replaces the symbolic references with a reference to the concrete memory location of the referenced class, field, or method. In an embodiment, the virtual machine 104 caches resolutions to be reused in case the same class/name/descriptor is encountered when the virtual machine 104 processes another class. For example, in some cases, class A and class B may invoke the same method of class C. Thus, when resolution is performed for class A, that result can be cached and reused during resolution of the same symbolic reference in class B to reduce overhead.

In some embodiments, the step of resolving the symbolic references during linking is optional. For example, an embodiment may perform the symbolic resolution in a “lazy” fashion, delaying the step of resolution until a virtual machine instruction that requires the referenced class/method/field is executed.

During initialization, the virtual machine 104 executes the constructor of the class to set the starting state of that class. For example, initialization may initialize the field and method data 306 for the class and generate/initialize any class instances on the heap 302 created by the constructor. For example, the class file 200 for a class may specify that a particular method is a constructor that is used for setting up the starting state. Thus, during initialization, the virtual machine 104 executes the instructions of that constructor.

In some embodiments, the virtual machine 104 performs resolution on field and method references by initially checking if the field/method is defined in the referenced class. Otherwise, the virtual machine 104 recursively searches through the super-classes of the referenced class for the referenced field/method until the field/method is located, or the top-level superclass is reached, in which case an error is generated.

### 3. CONCURRENCY MANAGEMENT SYSTEM

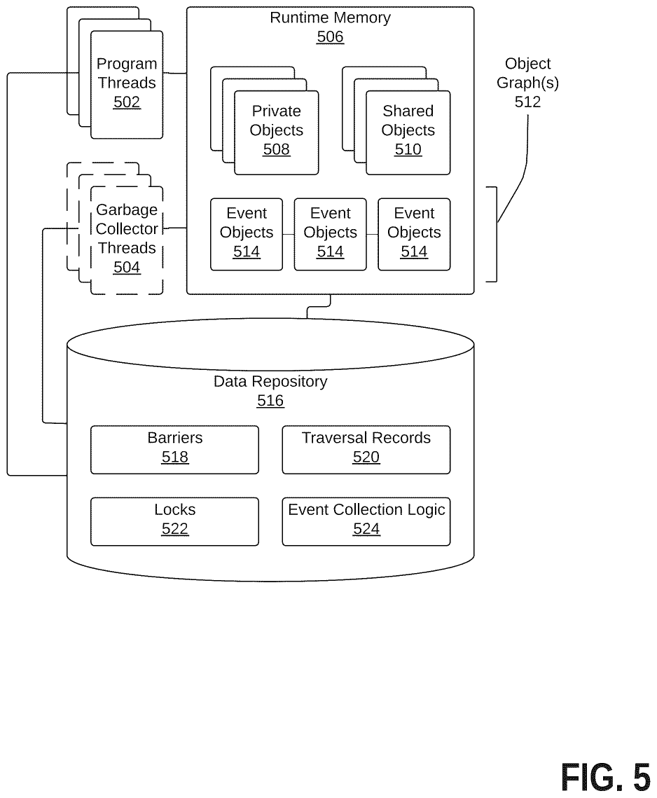

FIG. 5 illustrates a system 500 for performing techniques described herein in accordance with one or more embodiments. As illustrated in FIG. 5, system 500 may include program threads 502, garbage collector threads 504, runtime memory 506, and data repository 516. In one or more embodiments, the system 500 may include more or fewer components than the components illustrated in FIG. 5. The components illustrated in FIG. 5 may be local to or remote from each other. The components illustrated in FIG. 5 may be implemented in software and/or hardware. Each component may be distributed over multiple applications and/or machines. Multiple components may be combined into one application and/or machine. Operations described with respect to one component may instead be performed by another component.

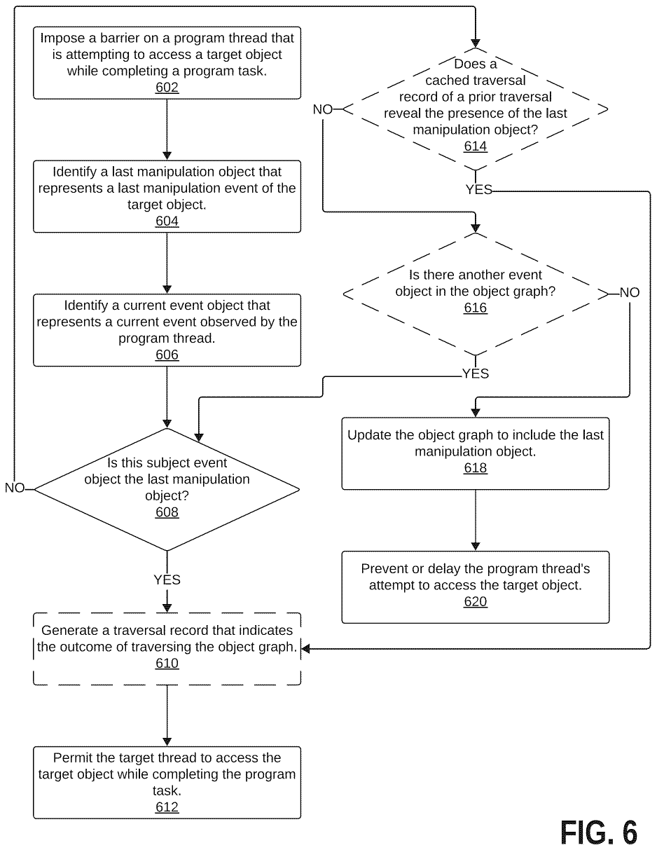

In one or more embodiments, system 500 refers to software and/or hardware configured for managing concurrent computing operations. To this end, system 500 is configured to perform concurrency checks. As used herein, the term “concurrency check” refers to a check for potential concurrency issues and/or causality bugs. For instance, by performing a concurrency check, the system can determine if an attempt to access shared information conflicts with some other access to that shared information in a manner that (a) potentially results in a concurrency issue and/or (b) is the result of a causality bug. Detecting conflicting accesses to shared information allows the system to avert potential concurrency issues and diagnose causality bugs. Example operations for performing a concurrency check are described below with reference to FIG. 6.

In an embodiment, system 500 is implemented in a computing environment that includes multiple threads of executions. A thread of execution, such as a program thread 502 or a garbage collector thread 504, is an independent execution environment for machine-level instructions. A multi-thread computing environment is an example of a computing environment that can perform concurrent operations. A typical implementation of the Java Runtime Environment is one example of a multi-thread computing environment. The implementation of system 500 in a threaded computing environment is described herein for illustrative purposes and is not intended to define any limits to this disclosure. A threaded computing environment is neither essential nor necessary to practice the techniques described herein. The techniques described herein are equally applicable to other computing architectures. In general, the techniques described herein are applicable to any computing architecture that can perform concurrent computing operations. The techniques described herein are applicable to both centralized computing systems and distributed computing systems.

In one or more embodiments, a program thread 502 refers to a thread of execution generally allocated for performing tasks at the behest of a program instance. A task performed at the behest of a program instance is referred to herein as a “program task.” Note that completing some program tasks may require manipulating information residing in runtime memory 506. For instance, while completing the requests of a program instance, a program thread 502 may be creating new data structures within runtime memory 506, reading from data structures residing in runtime memory 506, writing to data structures residing in runtime memory 506, and/or performing various other operations within runtime memory 506. Note that a program thread 502 may also be configured to perform tasks other than program tasks. For example, a program thread 502 may be configured to perform garbage collection tasks pursuant to barriers 518 that are imposed on the program thread 502.

In one or more embodiments, a garbage collector thread 504 refers to a thread of execution generally allocated for performing tasks at the behest of a garbage collection process. As used herein, the term “garbage collection” refers generally to memory management, and the term “garbage collection task” refers to a task performed in furtherance of a garbage collection process. In the example context of system 500, a garbage collection process may be configured to reclaim memory allocated to data structures residing within runtime memory 506 that are no longer needed by a currently executing program instance. In some embodiments, system 500 excludes dedicated garbage collector threads 504 because garbage collection tasks are delegated to program threads 502. In other words, in some embodiments, there may be no distinction between a program thread 502 and a garbage collector thread 504. As used herein, the term “garbage collector” refers to any thread that is performing a garbage collection task. As noted above, both program threads 502 and garbage collector threads 504 may perform garbage collection tasks. Thus, the term “garbage collector” may refer to a program thread 502, a garbage collector thread 504, or another thread.

In one or more embodiments, runtime memory 506 refers to a data repository that includes memory space allocated for the use of at least one program instance during runtime. For example, runtime memory 506 may include data structures, such as shared data structures and private data structures, generated by program threads 502 during program execution. In addition to information that can be manipulated by a program thread 502 at the behest of a program instance, runtime memory 506 may include information not exposed at a program level. For example, runtime memory 506 may include data structures and/or references to data structures that cannot be accessed by a program thread 502 while that program thread 502 is executing executable instructions of a program instance. Note that in this example, these data structures may be accessible to the program thread 502 if and when the program thread 502 is executing executable instructions of a lower-level process such as a garbage collection process. Runtime memory 506 may be implemented on any type of storage unit and/or device (e.g., a file system, database, collection of tables, or any other storage mechanism) for storing data. Furthermore, runtime memory 506 may be implemented on multiple different storage units and/or devices. The multiple different storage units and/or devices may or may not be of the same type or located at the same physical site. Runtime memory 506 may be implemented in volatile memory, and/or runtime memory 506 may be implemented in non-volatile memory.

In an embodiment, runtime memory 506 is implemented in the context of one or more class-based, object-oriented programming languages. Examples of class-based, object-oriented programming languages include Java, C++, C#, Python, Ruby, and others. The implementation of runtime memory 506 in the context of class-based, object-oriented program language(s) is described herein for illustrative purposes and is not intended to define any limits to the disclosure. A class-based, object-oriented programming language is neither essential nor necessary to practice the techniques described herein. The techniques described herein are equally applicable to other data structures, other computing environments, and other programming languages.

In an embodiment, information is represented within runtime memory 506 by runtime objects. A runtime object is a data structure that exists in memory during program execution (i.e., runtime). An example runtime object is an instance of a reference type such as a class. A runtime object may be conceptualized as a higher-level abstraction of binary data that resides somewhere in low-level memory. For example, a runtime object may be an abstraction of binary data stored to main memory (e.g., random access memory (RAM)). In the example illustrated in FIG. 3, runtime memory 506 may be implemented, in whole or in part, within heap 302.

In an embodiment, runtime memory 506 is subject to at least one garbage collection process during runtime. For example, during runtime, a garbage collection process may be configured to reclaim memory space allocated to runtime objects residing in runtime memory 506. In this example, the garbage collection process may classify memory space allocated to a runtime object as being eligible for reclamation if that runtime object has become less than strongly reachable. A runtime object is generally considered strongly reachable if there is at least one chain of strong reference(s) that can be traversed by at least one program thread 502 to access that runtime object at the behest of a program instance. The term “strong reference” refers to a reference that (a) fully participates in a reachability analysis performed by a garbage collector and (b) is not subjected to the collection rules applied to specialized references, such as soft references, weak references, phantom references, etc. If there is no chain of strong reference(s) that can be traversed by a program thread 502 to access a runtime object at the behest of a program instance, that runtime object will generally not be considered strongly reachable. Note that a runtime object being less than strongly reachable to a program thread 502 does not necessarily imply that the runtime object is unreachable to that program thread 502. For example, a runtime object that is not strongly reachable may remain reachable through a non-strong reference. Furthermore, the term “unreachable” is not necessarily synonymous with the term “inaccessible.” For example, a runtime object that is unreachable to a program thread 502 may remain accessible to a garbage collector thread 504. As used herein, the term “disposable” identifies information eligible for garbage collection, and the term “live” identifies information ineligible for garbage collection. While strongly reachable objects are generally live objects, note that the term “live” is not interchangeable with “strongly reachable.” For example, runtime objects that are less than strongly reachable, such as softly reachable objects, may be live objects in at least some cases. In other embodiments, runtime memory 506 is not subjected to a separate garbage collection process during runtime. For example, in these other embodiments, disposable information may be deallocated by threads while executing the executable instructions of a program instance. It should also be noted that event objects 514 may be subjected to special garbage collection rules different than the garbage collection rules that are applied to other runtime objects. Garbage collection rules for event objects 514 are discussed in greater detail below with respect to event collection logic 524.

In one or more embodiments, a private object 508 refers to a runtime object that a program instance can interact with through a single program thread 502. If a runtime object is a private object 508, there is a single program thread 502 that can access that runtime object at the behest of a program instance; no other program thread 502 can obtain a traversable reference to that runtime object while performing a program task. As noted above, some forms of “reachability” do not coincide with accessibility. Thus, a runtime object reachable to multiple program threads 502 may nonetheless be a private object 508. Note that the use of the word “private” as an adjective in the term “private object” does not refer to a private accessor flag. A private object 508 does not necessarily include a private field. In many cases, a private object 508 includes no private fields. Generally, a runtime object is initially a private object 508 when that runtime object is instantiated; after being instantiated, a private object 508 may become a shared object 514.

In one or more embodiments, a shared object 510 refers to a runtime object that a program instance can interact with through multiple program threads 502. Generally, a program instance is able to interact with a runtime object through a program thread 502 if there is at least one chain of references leading to the runtime object that can be traversed by the program thread 502 while executing the program instance. Note that some references, such as phantom references, cannot be traversed by a program thread 502 while executing a program instance. As noted above, multiple conflicting accesses to a shared object 510 may give rise to a concurrency issue. For example, two accesses to a shared object 510 conflict if (a) those two accesses are performed in furtherance of two separate tasks being performed concurrently and (b) at least one of those tasks is attempting to mutate the shared object 510. If the two conflicting accesses are allowed to occur in this example, a concurrency may arise. However, note that conflicting accesses do not necessarily result in a concurrency issue. It should also be noted that in some cases, two accesses to a shared object 510 may conflict even if both of those two accesses are reading from the shared object 510 and not mutating the shared object 510.

In one or more embodiments, an object graph 512 refers a set of related event object(s) 514. The event objects 514 within an object graph 512 may be connected by references that represent relationships between the corresponding events. For example, a reference between event objects 514 in an object graph 512 may reflect a causal relationship between the corresponding events, the temporal sequence of the corresponding events, and/or other relationships between the corresponding events. An object graph 512 may be a linear data structure or a non-linear data structure. Runtime memory 506 includes a single object graph 512 or multiple object graphs 512. Additionally, or alternatively, an object graph 512 may be maintained, in whole or in part, outside of runtime memory 506.

In an embodiment, an object graph 512 tracks a happens-before ordering of events. As noted above, a happens-before ordering is a relation among events where at least some pairs of events are ordered with respect to causal dependency. A happens-before ordering may or may not offer guarantees with respect to the real-time execution of events (i.e., the actual temporal sequence that events are performed and completed). In some cases, a happens-before ordering of events does not match a temporal sequence of these events. Additionally, or alternatively, an object graph 512 tracks a temporal sequence of events.

In an embodiment, an object graph 512 tracks a partial ordering of events. As noted above, a partial ordering refers to a happens-before ordering of a subset of events. For example, an object graph 512 of a thread may include event objects 514 that represent events that could feasibly conflict with other events, and the object graph 512 may exclude event objects 514 that represents events that cannot feasibly conflict with other events. Additionally, or alternatively, an object graph 512 tracks a total ordering of events. A “total ordering of events” refers herein to a relation among events where any given pair of events is ordered with respect to one another, so for any two distinct events, one is defined to occur before the other.

In an embodiment, an object graph 512 tracks an ordering of events that have been observed by a thread. For example, any given thread may be configured to maintain an object graph 512 that tracks events observed by that thread. In general, a thread may observe an event by partaking in the event and/or encountering an event object 514 that represents the event.

In an embodiment, an object graph 512 tracks a partial ordering of events observed by a thread. Events that are not observed by a thread may be unrepresented in that thread's object graph 512. Furthermore, events that pose no risk of contributing to a concurrency issue may also be unrepresented in an object graph 512. Additionally, or alternatively, other events may be unrepresented in an object graph 512.

In an embodiment, runtime memory 506 includes multiple object graphs 512 that respectively correspond to multiple threads. If runtime memory 506 includes multiple object graphs 512, the multiple object graphs 512 may intersect, or the multiple object graphs 512 may be distinct from one another. Object graphs 512 may intersect by including the same event object 514. Intersections between object graphs 512 of threads may be utilized to track a common ancestor state of runtime memory 506 with respect to the threads. In another embodiment, runtime memory 506 includes a single object graph 512.

In one or more embodiments, an event object 514 refers to a representation of an event that occurs in a computing environment. An event object 514 may represent a prior event, and/or an event object 514 may represent an event that is presently ongoing. An event object 514 may represent a successful event. For example, an event object 514 may represent a task that was successfully completed by a thread. An event object 514 may represent an unsuccessful event. For example, an event object 514 may represent an attempt to complete a task that was aborted due to a concurrency check revealing a potential concurrency issue associated with completing the task at the time the concurrency check was performed. Event objects 514 may include references to other event objects 514. For example, an event object 514 that represents one event may include a reference to another event object 514 that represents another event causally and/or temporally related to the one event. In this way, event objects 514 and the references between the event objects 514 may form an object graph 512 that tracks an ordering of events. An event object 514 may or may not be exposed at a program level. In some embodiments, an event object 514 is implemented as a runtime object. Additionally, or alternatively, an event object 514 is implemented as a data structure other than a runtime object.

In an embodiment, an event object 514 represents an event that accesses a runtime object. An event object 514 may represent an event that accesses a single runtime object or multiple runtime objects. An event represented by an event object 514 may create a runtime object, read from the runtime object, write to the runtime object, and/or otherwise manipulate the runtime object. An event represented by an event object 514 may manipulate no private objects 508, a single private object 508, or multiple private objects 508. Similarly, an event represented by an event object 514 may manipulate no shared objects 510, a single shared object 510, or multiple shared objects 510. An event represented by an event object 514 may mutate no runtime objects, a single runtime object, or multiple runtime objects. An event object 514 may represent an event performed at the behest of a program instance, and/or an event object 514 may represent an event performed at the behest of a garbage collection process or another process. In general, the events represented by event objects 514 may vary depending on the application. For instance, the events represented by event objects 514 may vary depending on a concurrency management model implemented in runtime memory 506. In some embodiments, any given interaction with a runtime object is represented by an event object 514. In other embodiments, a subset of the interactions with runtime objects are represented by event objects 514. If a subset of the interactions with runtime objects are represented by event objects 514, events that pose some risk or a higher risk of conflicting with other events are generally represented by event objects 514.

In an embodiment, an event object 514 represents an event that manipulates at least one shared object 510. An event represented by an event object 514 may or may not mutate a shared object 510. As noted above, an event that reads from and/or writes to a shared object 510 could conflict with another event that reads from and/or writes to that same shared object 510. Thus, creating event objects 514 to represent events that manipulate shared objects 510 allows system 500 to identify potentially conflicting accesses to shared objects 510.

In an embodiment, an event object 514 represents a latest event to manipulate a shared object 510. As used herein, the term “last manipulation event” refers to the latest event to manipulate a shared object 510 in a certain manner, and the term “last manipulation object” refers to an event object 514 that represents a last manipulation event. The verb “manipulate” may refer herein to any form of interaction. There may be a corresponding last manipulation object for any given shared object 510. A shared object 510 may include a field that tracks the shared object's 510 last manipulation event by holding a reference to the corresponding last manipulation object. Additionally, or alternatively, a shared object's last manipulation event may be tracked in another memory location. If an event manipulates multiple shared objects 510, the multiple shared object 510 may refer to a single corresponding last manipulation object. The types of interactions with a shared object 510 that constitute a last manipulation event may vary between embodiments. In an example, a shared object's 510 last manipulation event is the latest event that has created and/or mutated the state of the shared object 510. In this example, there may or may not be another more recent event that has read from, but not written to, this shared object 510. In another example, a shared object's 510 last manipulation event is the latest event that has accessed the shared object 510. For instance, in this other example, the last manipulation event may be the latest event to read from and/or write to the shared object 510. In this other example, there is not another event that has accessed this shared object 510 more recently than the last manipulation event.

In an embodiment, an event object 514 represents a latest event observed by a specific thread. As used herein, the term “current event” refers to the latest event observed by a thread, and the term “current event object” refers to an event object 514 that represents a thread's current event. There may be a corresponding current event object for any given thread. A thread may maintain a memory location that tracks the thread's current event by holding a reference to the corresponding current event object. For example, a reference to a current event object may be held by a local variable, a thread-local variable, some other thread-local storage mechanism, or some other memory location. A thread's current event may represent a task completed by that thread or another thread. Multiple threads may share the same current event. A thread's current event may be an ongoing event or a completed event. In an example of the latter scenario, a thread's current event represents a task that was completed successfully, or the thread's current event represents a task that was aborted.

In an embodiment, an event object 514 includes a traversal record 520. As noted below, a traversal record 520 refers to information describing a traversal of an object graph 512. For example, if a traversal is attempting to confirm if one event object 514 precedes another event object 514 in an object graph 512, the other event object 514 may include a traversal record 520 indicating the outcome of this traversal. An event object 514 includes no traversal records 520, a single traversal record 520, or multiple traversal records 520. Additionally, or alternatively, a traversal record 520 is stored in another memory location.

In an embodiment, an event object 514 includes a record of changes that occurred during a corresponding event. For example, an event object 514 representing an event may record a set of mutations applied to private objects 508 and/or shared objects 510 during the event.

In an embodiment, runtime memory 506 is subjected to a software transactional memory model for concurrency management, and an event object 514 represents a software memory transaction. A software transactional memory model for concurrency management may compel mutations to shared objects to occur through software memory transactions. Additionally, or alternatively, runtime memory 506 is subjected to a version-controlled memory model for concurrency management, and an event object 514 represents an attempt to commit mutations to at least one shared object 510 to create a new version of these shared objects 510.

In one or more embodiments, a data repository 516 refers to any type of storage unit and/or device (e.g., a file system, database, collection of tables, or any other storage mechanism) for storing data. Furthermore, a data repository 516 may include multiple different storage units and/or devices. The multiple different storage units and/or devices may or may not be of the same type or located at the same physical site. A data repository 516 may be implemented or executed on the same computing system as other components of system 500. Additionally, or alternatively, a data repository 516 may be implemented or executed on a computing system separate from other components of system 500. The data repository 516 may be communicatively coupled to other components of system 500 via a direct connection or via a network. As illustrated in FIG. 5, a data repository 516 may include information describing barriers 518, traversal records 520, locks 522, and/or event collection logic 524. Information describing barriers 518, traversal records 520, locks 522, and/or event collection logic 524 may be implemented across any of the components within the system 500. However, this information is illustrated within the data repository 516 for purposes of clarity and explanation.

In one or more embodiments, a barrier 518 refers to an additional set of executable instructions inserted into, or proximate to, executable instructions for completing a task. For example, while converting class files 103 of a program into machine-level code, JIT compiler 109 may insert barriers 518 into the machine-level instructions that correspond to the program tasks to be performed by a program thread 502. A barrier 518 is referred to herein as being “imposed” on a thread when the thread is actively performing the executable instructions defined in the barrier 518. Barriers 518 may be imposed on program threads 502, and/or barriers 518 may be imposed on garbage collector threads 504. By imposing a barrier 518 on a program thread 502 that is completing requests of a program instance (i.e., program tasks), system 500 may compel that program thread 502 to perform operations other than the operations requested by the program instance. Example barriers 518 that may be imposed on a thread include load barriers, store barriers, and others.

In an embodiment, a barrier 518 is a load barrier. As used herein, the term “load barrier” refers to a barrier 518 imposed on a thread in response to the thread being instructed to perform a load operation. An example load operation is a request by a program instance for a program thread 502 to load a reference to a runtime object. An example load barrier defines operations that a program thread 502 should perform before and/or after a load operation that triggers the imposition of the example load barrier.

In an embodiment, a barrier 518 is a store barrier. As used herein, the term “store barrier” refers to a barrier 518 imposed on a thread in response to the thread being instructed to perform a store operation. An example store operation is a request by a program instance for a program thread 502 to write a value to a location in memory such as an object field of a runtime object. An example store barrier defines operations that a program thread 502 should be required to perform before and/or after a store operation.

In an embodiment, a barrier 518 includes executable instructions for performing a concurrency check. As noted above, a concurrency check is a check for potential concurrency issues and/or causality bugs. Example mechanisms that may be leveraged by a barrier 518 to perform a concurrency check include object graphs 512, event tracing, execution tracing, Lamport timestamps, vector clocks, hybrid logical clocks, timestamps, read/write counters, locks 522, data-flow analysis, and others.

In an embodiment, a barrier 518 includes executable instructions for performing a concurrency check by traversing an object graph 512. For example, a barrier 518 may direct a thread to traverse an object graph 512 to determine if one event object 514 is present in the object graph 512 before another event object 514. Depending on the circumstances, if one event object 514 is not included in an object graph 512 before another event object 514, then the two events represented by these two event objects 514 may be causally inconsistent. If two events are causally inconsistent, then concurrently executing the operations associated with both events may result in a concurrency issue. Example traversals of an object graph 512 that may be performed pursuant to a barrier 518 include a linked list traversal, a directed acrylic graph traversal, a tree traversal, a depth-first traversal, a breadth-first traversal, a random walk traversal, a topological traversal, a bidirectional traversal, a priority-based traversal, a hierarchical traversal, and others.

In an embodiment, a barrier 518 includes executable instructions for performing a backwards traversal of an object graph 512. As used herein, the term “backwards traversal” refers to a traversal of an object graph 512 that proceeds from more recent event objects 514 to less recent event objects 514. For example, if a concurrency check is seeking to determine if one event object 514 precedes another event object 514 in an object graph 512, then a barrier 518 may direct a thread to perform a backwards traversal of the object graph 512 starting from the other event object 514 or a subsequent event object 514.

In an embodiment, a barrier 518 includes executable instructions for performing a forwards traversal of an object graph 512. As used herein, the term “forwards traversal” refers to a traversal of an object graph 512 that proceeds from a less recent event objects 514 to more recent event objects 514. For example, if a concurrency check is seeking to determine if one event object 514 precedes another event object 514 in an object graph 512, then a barrier 518 may direct a thread to perform a forwards traversal of the object graph 512 starting from the one event object 514 or a prior event object 514.

In an embodiment, a barrier 518 includes executable instructions for performing a backwards traversal of an object graph 512, and/or the barrier 518 includes executable instructions for performing a forwards traversal of an object graph 512. For example, a barrier 518 may direct a thread to perform both a forwards traversal and a backwards traversal of an object graph 512 if the event object 514 that is being sought is not identified during whichever traversal is performed first. Note that if an object graph 512 is a non-linear data structure, performing both a forwards traversal and a backwards traversal may be warranted to confirm the presence or absence of an event object 514 in the object graph 512.

In an embodiment, a barrier 518 includes executable instructions for selectively preventing or delaying a thread from performing certain operations. For example, if a concurrency check indicates a program task is causally inconsistent with some other task, a barrier 518 may direct a thread to abort, postpone, and/or restart the program task. A barrier 518 may block a thread from performing a subset of a task, and/or a barrier 518 may block a thread from performing the entirety of a task. Additionally, or alternatively, a barrier 518 may include executable instructions for performing other corrective actions. For example, a barrier 518 may direct a thread to flag a causal inconsistency associated with a causality bug, abort a program instance, and/or perform other operations.

In an embodiment, a barrier 518 includes executable instructions for recording an event. For example, in response to a program instance requesting a program thread 502 to perform a task, a barrier 518 may direct the thread to create an event object 514 to represent the program thread's 502 forthcoming attempt to complete that task. In this example, the program thread 502 may maintain a thread-local storage mechanism used to track a current event of the program thread 502, and the barrier 518 may further direct the program thread 502 to remap a reference in this thread-local storage mechanism to point to the newly created event object 514. Thereafter, the newly created event object 514 is the program thread's 502 new current event object in this example.

In an embodiment, a barrier 518 includes executable instructions for updating an object graph 512 to record the order of an event. For example, after a program thread 502 creates a new event object 514 and designates this new event object 514 as the program thread's 502 new current event object, a barrier 518 may further direct the program thread 502 to add the new event object 514 to the program thread's 502 object graph 512. In this example, the barrier 518 directs the program thread 502 to add the new event object 514 to the object graph 512 by storing a reference in the new event object 514 that points to another event object 514 in the object graph 512. For instance, in this example, the reference may point to what was formerly the program thread's 502 current event object in the object graph 512.

In an embodiment, a barrier 518 includes executable instructions for tracking a last mutation event of a shared object 510. For example, if a program thread 502 is permitted to perform a program task that mutates a shared object 510, a barrier 518 may direct the program thread 502 to update a field in the shared object 510 used to track the shared object's 510 last mutation event. In particular, the barrier 518 of this example may direct the program thread 502 to remap a reference in this field to point to an event object 514 that represents the program thread's 502 successful attempt to complete the program task.

In an embodiment, a barrier 518 includes executable instructions for acquiring a lock 522 on a shared object 510. As an example, assume that a program thread 502 is attempting a program task that involves mutating a shared object 510. In this example, a barrier 518 is imposed on the program thread 502, and the barrier 518 directs the program thread 502 to acquire a lock 522 on the shared object 510 before attempting to mutate the shared object 510 while completing the program task. If the program thread 502 is unable to acquire a lock on the shared object 510 in this example, the barrier may direct the program thread 502 to prevent or delay the completion of the program instance's request. If the program thread 502 successfully acquires a lock 522 on the shared object 510 in this example, the barrier 518 may direct the program thread 502 to perform a concurrency check on the shared object 510 before and/or after acquiring the lock 522 on the shared object 510. Furthermore, in this example, the barrier 518 may direct the program thread 502 to release the lock 522 on the shared object 510 after performing the concurrency check and/or mutating the shared object 510. Note that an attempt to acquire a lock 522 on a shared object 510 at the direction of a barrier 518 may, in itself, serve as another concurrency check. If one thread acquires a lock on a shared object 510 before attempting one program task that involves accessing the shared object 510, then another thread may be prevented from concurrently acquiring a lock on that shared object 510 before concurrently attempting another program task that involves accessing the shared object 510. Thus, if a thread is unable to acquire a lock on a shared object 510, then the thread may be able to conclude that another thread is attempting to concurrently access that shared object 510 in a manner potentially associated with a concurrency issue and/or causality bug.

In an embodiment, a barrier 518 includes executable instructions for performing garbage collection tasks. In this way, a barrier 518 may be utilized to temporarily commandeer a program thread 502 for garbage collection in runtime memory 506. A barrier 518 may direct a thread to perform garbage collection tasks directed to private objects 508, shared objects 510, event objects 514, and/or any other information.

In one or more embodiments, a traversal record 520 refers to information describing a traversal of an object graph 512. As noted above, a traversal of an object graph 512 may be performed to determine if a particular event object 514 is present in the object graph 512. Thus, a traversal record 520 may indicate if a particular event object 514 was identified in an object graph 512 during a traversal. Furthermore, a traversal record 520 may indicate the relative position of a particular event object 514 within an object graph 512. For example, a traversal record may indicate that one event object 514 precedes another event object 514 in an object graph 512. Note that a traversal record 520 of a prior traversal of an object graph 512 may serve as a basis for expediting a subsequent traversal of the object graph 512. As noted above, a traversal record 520 may be cached to an event object 514. Additionally, or alternatively, a traversal record 520 may be cached to another location in memory. In an example, traversal records 520 are implemented as hash maps.

In one or more embodiments, a lock 522 refers to a mechanism for controlling access to shared information. For instance, a lock 522 may be used to restrict access to a shared object 510. If a thread holds a lock 522 on a shared object 510, other threads may be prevented from manipulating that shared object 510 if the thread retains the lock 522 on the shared object 510. Example locks 522 that may be utilized by system 500 to restrict access to shared information include mutex locks, read-write locks, spinlocks, re-entrant locks, semaphore locks, and others.

In one or more embodiments, event collection logic 524 refers to executable instructions for performing garbage collection tasks on event objects 514. For instance, event collection logic 524 may include executable instructions for rendering an event object 514 disposable if and when the event object 514 is no longer needed for performing concurrency checks or other functions. Additionally, or alternatively, event collection logic 524 may include executable instructions for reclaiming memory space allocated to disposable event objects 514. By pruning an object graph 512 of superfluous event objects 514, executing event collection logic 524 reduces the memory resources occupied by the object graph 512 as well as the processing resources needed to fully traverse the object graph 512. Therefore, executing event collection logic 524 generally improves the efficiency of performing concurrency checks based on an object graph 512. Event collection logic 524 may be executed by program threads 502, garbage collector threads 504, and/or other garbage collectors. Event collection logic 524 may be encoded into barriers 518, garbage collection logic executed by garbage collector threads 504, and/or the executable instructions of a program instance.

In an embodiment, event collection logic 524 includes executable instructions for rendering event objects 514 eligible for garbage collection. For example, if an event object 514 in an object graph 512 is no longer needed to perform concurrency checks, event collection logic 524 may direct a thread to render that event object 514 eligible for garbage collection, so this event object 514 will be reclaimed by a forthcoming garbage collection cycle. In general, how an event object 514 is rendered disposable will vary depending on the garbage collection rules that are applied to event objects 514.

In an embodiment, event objects 514 are subjected to the same or similar garbage collection rules that are applied to other runtime objects, and event collection logic 524 includes executable instructions for selectively rendering event objects 514 disposable pursuant to these garbage collection rules. As an example, assume that runtime objects are generally subjected to reachability-based garbage collection rules. As noted above, if a runtime object is less than strongly reachable, that runtime object may be disposable pursuant to reachability-based garbage collection rules. Therefore, in this example, if an event object 514 is not needed to perform concurrency checks, event collection logic 524 may instruct a thread to render this event object 514 less than strongly reachable, so memory space occupied by this event object 514 can be reclaimed by a forthcoming garbage collection cycle.

In an embodiment, event collection logic 524 includes special garbage collection rules for event objects 514 that may differ from the garbage collection rules applied to other runtime objects. As an example, assume that runtime objects are generally subjected to reachability-based garbage collection rules. In this example, event collection logic 524 may call for the reclamation of memory space allocated to an event object 514 even if that event object 514 remains strongly reachable.

In an embodiment, event collection logic 524 dictates that an event object 514 may be disposable or should be rendered disposable if that event object 514 is no longer a last mutation object for any shared object 510. For example, if there is no shared object 510 that refers to an event object 514, then that event object 514 may no longer be needed to perform concurrency checks. Therefore, in this example, event collection logic 524 may classify this event object 514 as disposable, or event collection logic 524 may instruct a thread to render this event object 514 disposable pursuant to the applicable garbage collection rules.

In an embodiment, event collection logic 524 dictates that an event object 514 may be disposable or should be rendered disposable if the presence of that event object 514 in an object graph 512 is recorded by a traversal record 520. For example, if the presence of an older event object 514 in an object graph 512 is recorded in a traversal record 520 cached to a more recent event object 514 in the object graph 512, then there may be no need to retain the older event object 514 in the object graph 512 because the information needed to perform concurrency checks associated with the older event object 514 is recorded by the traversal record 520.

In an embodiment, event collection logic 524 dictates that a newer event object 514 may be disposable or should be rendered disposable if older event objects 514 that are reachable from the newer event object 514 are also disposable. On the other hand, if older event objects 514 that are reachable from a newer event object 514 are not disposable, event collection logic 524 may call for the retention of the newer event object 514 even if the newer event object 514 would otherwise be eligible for disposal by a garbage collection process.

In an embodiment, system 500 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 4. PERFORMING A CONCURRENCY CHECK

FIG. 6 illustrates an example set of operations for performing a concurrency check in accordance with one or more embodiments. One or more operations illustrated in FIG. 6 may be modified, rearranged, or omitted. Accordingly, the sequence of operations illustrated in FIG. 6 should not be construed as limiting the scope of one or more embodiments. In an embodiment, the operations illustrated in FIG. 6 are performed in the context of a multi-threaded computing environment implemented using one or more object-oriented programming languages. To provide a concise explanation and clear examples, the remainder of this section will assume the same. However, neither a threaded computing environment nor an object-oriented programming language are essential or necessary to practice the techniques described herein. The techniques described herein are equally applicable to other concurrent computing environments and other programming languages.

In one or more embodiments, the system imposes a barrier on a thread attempting to access a shared object (Operation 602). Hereafter, the shared object that the thread is attempting to access is referred to as “the target object.” The thread is attempting to access the target object pursuant to executable instructions of a program instance being executed, at least in part, by this thread. In particular, the program instance is requesting the thread to perform some task that involves reading from, writing to, and/or otherwise interacting with the target object. Hereafter, this task that entails accessing the target object is referred to as “the program task,” and the thread attempting to complete the program task is referred to as “the program thread.” As noted above, a barrier is an additional set of executable instructions inserted into, or proximate to, executable instructions for completing a task. The system imposes the barrier on the program thread by inserting the barrier into, or in proximity to, the program instance's executable instructions for completing the program task. For example, the barrier may be a load barrier imposed on the program thread proximate to executable instructions for loading a reference to the target object, or the barrier may be a store barrier imposed on the program thread proximate to executable instructions for writing to the target object. In another example, the barrier is imposed on the thread at the outset of the program task.

In an embodiment, the barrier directs the program thread to acquire a lock on the target object before performing a concurrency check as described below. If the program thread is unable to acquire a lock on the target object, the barrier may direct the program thread to prevent or delay the program task. Note that an inability of the program thread to acquire a lock on the target object may be the result of another thread presently holding the lock on the target object. If another thread presently holds the lock on the target object, then this other thread may be attempting to access the shared object while completing some other request of the program instance while the program thread is concurrently attempting to complete the program task. In another embodiment, the program thread is directed to acquire the lock on the target object after performing the concurrency check.

In one or more embodiments, the program thread, acting pursuant to the barrier, identifies a last manipulation object that represents the last manipulation event of the target object (Operation 604). As noted above, a shared object's last manipulation event is the latest event to manipulate the shared object in a certain manner. The last manipulation event may have created the target object, written to the target object, read from the target object, and/or otherwise manipulated the target object. The last manipulation event was performed by the program thread or another thread. The last manipulation event may or may not be the latest event to access the target object in some way. The thread may identify the last manipulation object by traversing a reference that points to the last manipulation object. For example, the target object may include a field tracks the last manipulation event. In this example, this field currently holds a reference that points to the last manipulation object, and the thread identifies the last manipulation event by traversing this reference.

In an embodiment, the last manipulation event is the latest event to mutate the target object. For example, the last manipulation event may be the latest event to create and/or alter the current state of the target object. Note that in this example, there may be another event that has read from, but not written to, the target object after the last manipulation event. In another embodiment, the last manipulation event is the latest event to access the target object. For example, the last manipulation event may be the latest event to read from and/or write to the target object. In this example, there is no other event that has accessed the target object more recently than the last manipulation event.

In one or more embodiments, the program thread, acting pursuant to the barrier, identifies a current event object that represents the program thread's current event (Operation 606). As noted above, a thread's current event is the latest event observed by that thread. The program thread's current event may be performed by the program thread, or the program thread's current event may be an event performed by another thread and observed by the program thread. The current event may be completed or ongoing. In an example of the latter scenario, the current event corresponds to the program thread's ongoing attempt to complete the program task. The current event object is the latest event object in an object graph of event objects observed by the program thread (referred to hereafter as “the object graph”). Thus, the current event object may serve as a starting point for traversing the object graph. The program thread identifies the current event object by traversing a reference that points to the current event object. For example, a thread-local storage mechanism of the program thread may be dedicated to tracking the program thread's current event, and this thread-local storage mechanism may include a reference to the current event object. In this example, the program thread identifies the current event object by traversing this reference. In traversing a reference to identify the current event object in this embodiment, the program thread begins the traversal of the object graph. In another embodiment, the barrier directs the program thread to begin the traversal of the object graph starting with a different event object. For example, the barrier may direct the program thread to begin a traversal of the object graph starting from the last manipulation object.

In one or more embodiments, the program thread, acting pursuant to the barrier, determines if this event object is the last manipulation object, and the barrier directs the program thread to proceed to another operation based on the outcome of this determination (Operation 608). Hereafter, this event object that the program thread is presently comparing to the last manipulation object is referred to as “the subject event object.” If the program thread traverses the object graph starting with the current event object, and if the program thread has just initiated the traversal of the object graph, the current event object is the subject event object. Otherwise, if the program thread's traversal of the object graph has already progressed beyond the current event object, or if the program thread's traversal of the object graph is started from a different event object, the subject event object is another event object in the object graph that precedes the current event object. If the subject event object is the last manipulation object, then the barrier directs the program thread to proceed to Operation 610. In this scenario, the program thread has successfully confirmed the presence of the last manipulation object in the object graph; accordingly, it may be assumed that the program thread's present attempt to access the target object is causally consistent with the last manipulation event. Therefore, in this scenario, the barrier may permit the program thread to access the target object pursuant to the program instance's executable instructions for completing the program task. Alternatively, if the subject event object is not the last manipulation object, then the barrier directs the program thread to proceed to Operation 614. In this alternative scenario, the program thread has not yet confirmed the presence of the last manipulation object in the object graph; accordingly, the traversal of the object graph may continue until the program thread confirms if the last manipulation object is present in the object graph.

In one or more embodiments, the program thread, acting pursuant to the barrier, generates a traversal record that indicates the outcome of traversing the object graph (Operation 610). In this scenario, the program thread has confirmed that the last manipulation object is present in the object graph, and the traversal record indicates the same. The program thread caches this traversal record in memory location where the traversal record can be referenced during subsequent traversals. For instance, the program thread may cache the traversal record in the current event object and/or another event object in the object graph. Additionally, or alternatively, the program thread may cache the traversal record in another memory location. Note that the cached traversal record may serve as a means for expediting other traversals of the object graph seeking the last manipulation object. As an example, assume that the program thread caches the outcome of the traversal in the current event object, and further assume that a subsequent traversal of the object graph is seeking to confirm if the last manipulation object is present in the object graph before another event object that is added to the object graph after the current event object. Rather than having to traverse the object graph until encountering the last manipulation object, the subsequent traversal may need to progress no further than the current event object because the cached traversal record in the current event object confirms the presence of the last manipulation object in the object graph prior to the current event object.

In one or more embodiments, the barrier may permit the program thread to access the target object while completing the program task (Operation 612). In this scenario, the traversal of the object graph confirmed that the last manipulation object is present in the object graph. Having confirmed the presence of the last manipulation object in the object graph, it may be assumed that the program thread's present attempt to access the target object is causally consistent with the last manipulation event. Thus, the barrier may permit the program thread to proceed with accessing the target object while completing the program task. However, note that if completing the program task involves some other operation that is problematic, the program thread may not be permitted to access the target object even though this interaction with the target object is not associated with any potential concurrency issue or causality bug. For example, if completing the program task involves some other interaction with another shared object found to be associated with a potential concurrency issue and/or causality bug, a barrier may prevent or delay the program thread from performing some or all the operations associated with the program task.

In an embodiment, the program thread was previously directed to acquire a lock on the target object, and the program thread is directed to release the lock on the target object after accessing the target object while completing the program task. In an example, the program thread releases the lock on the target object at the direction of another barrier imposed on the program thread after the program thread completes at least the portion of the program task that involves accessing the target object.

In one or more embodiments, the program thread, acting pursuant to the barrier, determines if a cached traversal record of a prior traversal confirms the presence of the last manipulation object in the object graph, and the barrier directs the program thread to proceed to another operation based on the outcome of this determination (Operation 614). In this scenario, the program thread has already determined that the subject event object is not the last manipulation object. However, a cached traversal record of a prior traversal may indicate if the last manipulation object is present in the object graph. Therefore, the program thread is directed to check for any relevant traversal records. For example, the program thread may inspect the subject event object to determine if there are any traversal records cached therein that indicate the last manipulation object is present in the object graph before the subject event object. If a cached traversal record of a prior traversal of the object graph indicates that the last manipulation object is present in the object graph, then the barrier directs the program thread to proceed to Operation 610. Alternatively, if there is no cached traversal record of a prior traversal that indicates the presence of the last manipulation object in the object graph, then the barrier directs the program thread to proceed to Operation 616.

In one or more embodiments, the thread, acting pursuant to the barrier, determines if there is another event object that precedes the subject event object in the object graph, and the barrier directs the program thread to proceed to another operation based on the outcome of this determination (Operation 616). If there is another event object that precedes the subject event object in the object graph, then the barrier directs the program thread to return to Operation 608. In this scenario, the program thread will traverse a reference pointing from the subject event object to the preceding event object, and the program thread will then evaluate the preceding event object with respect to the last manipulation object. In other words, the preceding event object will become the new subject event object. Alternatively, if there is not another event object that precedes the subject event object in the object graph, then the barrier directs the program thread to proceed to Operation 618. In this alternative scenario, the program thread has fully traversed the object graph without having identified the last manipulation object; this implies that the last manipulation event has not previously been observed by the program thread, and the program thread's present attempt to access the target object may be causally inconsistent with the last manipulation event. As noted above, causally inconsistent accesses to a shared object can result in concurrency issues and may be the result of a causality bug in the program instance.

In one or more embodiments, the program thread, acting pursuant to the barrier, updates the object graph to include the last manipulation object (Operation 618). The barrier may direct the program thread to insert the last manipulation object into the object graph before or after the current event object. In general, the program thread inserts the last manipulation object into the object graph by creating and/or remapping references to event objects. As an example, assume the current event object represents the program thread's ongoing attempt to complete the program task. In this example, the barrier directs the program thread to insert the last manipulation object into the object graph before the current event object, so the object graph indicates the last manipulation event happened before the current event (i.e., the program task the program thread is currently attempting). To this end, the program thread stores a new reference in the last manipulation object to a preceding event object present in the object graph in this example, and the program thread remaps a reference held by the current event object from the preceding event object to the last manipulation object. As a result, in this example, the last manipulation object is inserted into the object graph after the preceding event object and before current event object. As another example, assume the current event has already been completed. In this other example, the barrier may direct the program thread to insert the last manipulation object into the object graph after the current event object. Accordingly, the program thread may add the last manipulation object to the object graph by storing a reference in the last manipulation object that refers to the current event object in this other example. Furthermore, in this other example, the barrier may direct the program thread to remap a reference held in a thread-local storage mechanism used by the program thread to track the program thread's current event. In particular, the program thread may be directed to remap this reference to point to the last manipulation object in this example. Accordingly, in this example, the last manipulation objects becomes the program thread's new current event object. In the foregoing examples, the object graph is a linear data structure. In yet another example, the object graph is a non-linear data structure, and the program thread adds the last manipulation object to the object graph by storing, within the current event object or a preceding event object, a reference that points to the last manipulation object.

In one or more embodiments, the barrier prevents or delays the program thread's attempt to access the target object (Operation 620). The barrier prevents or delays the program thread's attempt to access the target object because the program thread failed to locate the last manipulation object while traversing the object graph. Therefore, it cannot be assumed that the program thread's present attempt to access the target object while completing the program task is causally consistent with the last manipulation event, and the barrier prevents or delays the program thread's present attempt to access the target object to ensure this access does not lead to a concurrency issue resulting from causally inconsistent accesses to the target object. In addition to being prevented or delayed from accessing the target object, the program thread may be prevented or delayed from performing other operations associated with the program task. Note that if (a) the program thread is compelled to abort the present attempt to complete the program task, (b) the program instance subsequently instructs the program thread to make another attempt to complete the program task, and (c) there is no other intervening access to the target object, then the program thread's subsequent attempt to access the target object while reattempting the program task will generally be successful because the last manipulation event is now represented within the object graph. Additionally, or alternatively, the barrier may direct the program thread to flag this causal inconsistency as a manifestation of a causality bug in the program instance, terminate the program instance, release a lock on the shared object, and/or perform other operations.

### 5. EXAMPLE EMBODIMENT

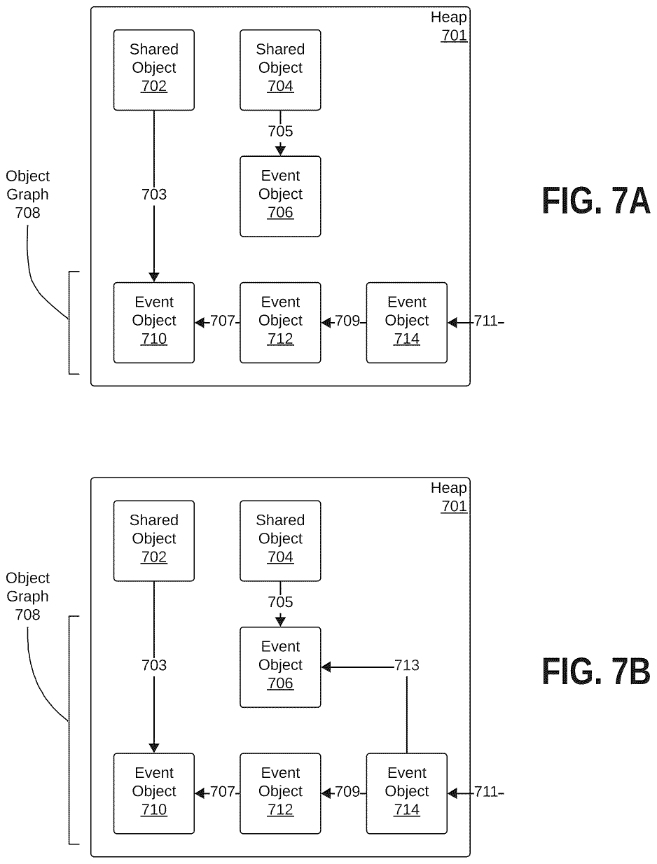

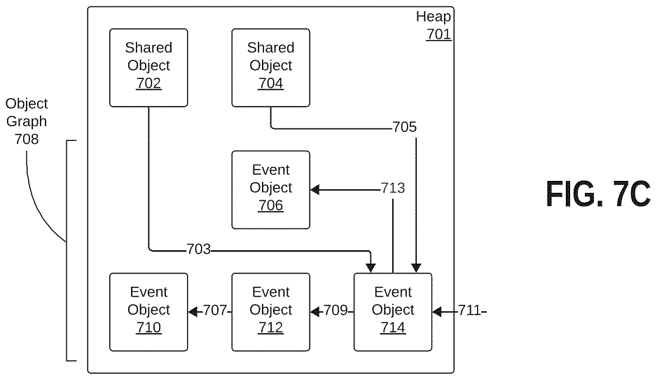

FIGS. 7A, 7B, and 7C illustrate the impact of an example set of operations for managing concurrent computing operations in accordance with an example embodiment. In particular, FIGS. 7A, 7B, and 7C illustrate the impact of an example set of operations that may be performed by a thread at the direction of barriers imposed on a thread attempting to manipulate shared memory pursuant to the executable instructions of a program instance. Hereafter, this thread is referred to as the “program thread.” Note that in some applications, the operations performed by the program thread at the direction of the barriers may be intertwined with operations performed by the program thread pursuant to the executable instructions of the program instance. In an alternative example, the operations described below are defined in the executable instructions of a program instance and/or are performed by another thread. A detailed example is described below for purposes of clarity. Components and/or operations described below should be understood as one specific example that may not be applicable to certain embodiments. Accordingly, components and/or operations described below should not be construed as limiting the scope of any of the claims.

In an example embodiment, the program thread creates event object 714 to represent a first attempt by the program thread to complete a task the program instance is instructing the program thread to perform. Hereafter, the task the program instance is instructing the program thread to perform is referred to as “the program task.” In this example, completing the program task entails manipulating shared object 702 and shared object 704. The program thread creates event object 714 pursuant to a barrier imposed on the program thread in response to the program instance instructing the program thread to perform the program task. In addition to instantiating event object 714, the program thread, acting pursuant to the barrier, adds event object 714 to the program thread's object graph 708 that already includes event object 710 and event object 712. The program thread adds event object 714 to object graph 708 by storing, within event object 714, a reference 709 that points to event object 712. In other words, the program thread creates and/or updates event object 714, so event object 714 refers to the event object corresponding to the latest event observed by the program thread prior to the first attempt to complete the program task (i.e., event object 712). Event object 714, referring to event object 712, indicates that event object 714 is ordered after event object 712 in the ordering of events tracked by the object graph 708. Following the inclusion of event object 714 in object graph 708, the event corresponding to event object 714 is now ordered after the event corresponding to event object 712 in the ordering of events tracked by the object graph 708. Thus, event object 714 is now the latest event observed by the program thread. To reflect this change, the program thread, acting pursuant to the barrier, remaps a reference 711 from event object 712 to event object 714. Reference 711 is maintained in a thread-local storage mechanism of the program thread tracks the program thread's current event. Thus, after reference 711 is remapped to point to event object 714, event object 714 is the program thread's new current event object. The state of heap 701 following the foregoing operations is illustrated in FIG. 7A.

In an example embodiment, the program thread, acting pursuant to a barrier, initiates a first concurrency check on shared object 702 by traversing a reference 703 that originates from shared object 702 and that points to event object 710. This barrier is the same barrier that directs the program thread to create event object 714, or this barrier is a different barrier imposed on the program thread at a later point during the first attempt to complete the program task. The barrier directs the program thread to perform the first concurrency check on shared object 702 because completing the program task entails manipulating shared object 702. The field holding reference 703 tracks the last mutation event of shared object 702. By traversing reference 703 to event object 710, the program thread ascertains that the event corresponding to event object 710 is the shared object's 702 last manipulation event. Note that the program thread has not yet been permitted to manipulate shared object 702 while attempting to complete the program task.

In an example embodiment, the program thread, acting pursuant to a barrier, begins a first traversal of object graph 708 by traversing reference 711 to event object 714, and the program thread compares event object 710 to event object 714. As noted above, reference 711 is maintained in a thread-local storage mechanism of the program thread, and the reference 711 currently points to event object 714. Recall that event object 714 currently represents the first attempt to complete the program task. The program thread compares event object 710 to event object 714 to determine if these two event objects are the same event object. Based on this comparison, the program thread discerns that event object 714 is not event object 710. In determining that event object 714 is not event object 710, the program thread determines that the program thread event corresponding to event object 714 is not the latest event to mutate shared object 710. In addition to the foregoing comparison, the program thread checks if there are any pertinent traversal records cached to event object 714. In particular, the program thread checks for a traversal record that indicates if event object 710 precedes event object 714 in object graph 708. For the purposes of this example, assume that no such traversal record is cached to event object 714. Accordingly, the program thread will proceed onward with the first traversal of object graph 708.

In an example embodiment, the program thread, acting pursuant to a barrier, traverses a reference 709 originating from event object 714 and pointing to event object 712, and the program thread compares event object 710 to event object 712. Based on this comparison, the program thread discerns that event object 712 is not event object 710. Furthermore, the program thread checks for pertinent traversal records cached to event object 712. In this example, the program thread determines there is no traversal record cached to event object 712 that indicates if event object 710 precedes event object 714 in object graph 708. Accordingly, the program thread will proceed onward with the first traversal of the object graph 708.

In an example embodiment, the program thread, acting pursuant to a barrier, traverses a reference 707 that originates from event object 712 and that points to event object 710, and the program thread confirms the presence of event object 710 in object graph 708 upon traversing this reference 707. In particular, the program thread confirms event object 710 is present in object graph 708 before the event object 714 (i.e., the event object corresponding to the first attempt to complete the program task). Accordingly, the program thread may assume that manipulating shared object 702 during the first attempt to complete the program task is causally consistent with the last mutation to shared object 702 (i.e., the event corresponding to event object 710). This conclusion marks the end of the first traversal of object graph 708 and the first concurrency check on shared object 702.

In an example embodiment, the program thread, acting pursuant to a barrier, caches a record of the first traversal of object graph 708. This traversal record indicates event object 710 is present in object graph 708 before event object 714. The program thread caches this traversal record to event object 714. Note that in this example, this traversal record will be used to expediate a subsequent traversal of object graph 708.

In an example embodiment, the program thread, acting pursuant to a barrier, initiates a second concurrency check on shared object 704 by traversing a reference 705 that originates from shared object 704 and that points to event object 706. This barrier is the same barrier that directed the program thread to perform the first concurrency check on shared object 702, or this barrier is a different barrier imposed on the program thread at a later point during the first attempt to complete the program task. The barrier directs the program thread to perform the second concurrency check on shared object 704 because completing the program task entails manipulating shared object 704. The field that holds reference 705 tracks shared object 704's last manipulation event. By traversing reference 705 to event object 706, the program thread ascertains that the event corresponding to event object 706 is the shared object's 704 last manipulation event. Note that the program thread has not yet been permitted to manipulate shared object 704 while attempting to complete the program task.

In an example embodiment, the program thread, acting pursuant to a barrier, begins a second traversal of object graph 708 by traversing the reference 711 to event object 714, and the program thread compares event object 706 to event object 714. Based on this comparison, the program thread discerns event object 714 is not event object 706. In addition to the foregoing comparison, the program thread checks if there are any pertinent traversal records cached to event object 714. In particular, the program thread checks for a traversal record that indicates if event object 706 precedes event object 714 in object graph 708. For the purposes of this example, assume that no such traversal record is cached to event object 714. Accordingly, the program thread will proceed onward with the second traversal of object graph 708.

In an example embodiment, the program thread, acting pursuant to a barrier, traverses the reference 709 that originates from event object 714 and that points to event object 712, and the program thread compares event object 706 to event object 712. Based on this comparison, the program thread discerns event object 712 is not event object 706. Furthermore, the program thread checks for pertinent traversal records cached to event object 712. In this example, the program thread determines there is no traversal record cached to event object 712 that indicates if event object 706 precedes event object 712. Accordingly, the program thread will proceed onward with the second traversal of object graph 708.

In an example embodiment, the program thread, acting pursuant to a barrier, traverses the reference 707 originating from event object 712 and pointing to event object 710, and the program thread compares event object 706 to event object 710. Based on this comparison, the program thread discerns event object 710 is not event object 706. In addition to the foregoing comparison, the program thread checks for pertinent traversal records cached to event object 710. In this example, the program thread determines there is no traversal record cached to event object 710 that indicates if event object 706 precedes event object 710 in object graph 708. After evaluating event object 710, the program thread has now fully traversed object graph 708 without finding event object 706. Based on this outcome, the program thread concludes that the event corresponding to event object 706 (i.e., the last mutation to shared object 704) may be causally inconsistent with manipulating shared object 704 during the first attempt to complete the program task. As a result, the barrier blocks the first attempt to complete the program task. In particular, the barrier blocks the program thread from manipulating shared object 704, shared object 702, and/or other runtime objects during the first attempt to complete the program task.

In an example embodiment, the program thread, acting pursuant to a barrier, adds event object 706 to object graph 708. The program thread adds event object 706 to object graph 708 by storing, within event object 714, a reference 713 that points to event object 706. By updating event object 714 so that event object 714 refers to event object 706, the program thread records that event object 706 occurred before event object 714 in the ordering of events tracked by object graph 708. The state of heap 701 following the foregoing operations is illustrated in FIG. 7B. Note that in this example, object graph 708 is a non-linear object graph that may include divergent chains of references. In other examples, object graph 708 is a linear object graph. It should also be noted that in this example, event object 706 may already be included in other object graphs (not depicted by FIG. 7A, 7B, or 7C) belonging to other threads. Thus, the inclusion of event object 706 within object graph 708 may result in a new intersection between these object graphs.

In an example embodiment, the program thread, acting pursuant to a barrier, initiates a third concurrency check on shared object 702 by traversing the reference 703 that originates from shared object 702 and that points to event object 710. This barrier is imposed on the program thread in response to the program instance instructing the program thread to pursue a second attempt to complete the program task. This barrier directs the program thread to perform the third concurrency check on shared object 702 because completing the program task entails manipulating shared object 702, and it is possible that a thread has mutated shared object 702 in the time that has elapsed since the program thread completed the first concurrency check on shared object 702. As noted above, the field holding reference 703 tracks the last manipulation event of shared object 702. By traversing this reference 703 to event object 710, the program thread ascertains that the event corresponding to event object 710 remains the last manipulation event of shared object 702. Note that the program thread was not permitted to manipulate shared object 702 during the first attempt to complete the program task, and the program thread has not yet been permitted to manipulate shared object 702 during the second attempt to complete the program task. It should also be noted that in this example, the first and second attempt to complete the program task will be represented by the same event object (i.e., event object 714). Accordingly, the program thread does not create a new event object for the second attempt to complete the program task in this example. In other examples, separate attempts to complete the same task are represented by separate event objects.

In an example embodiment, the program thread, acting pursuant to a barrier, begins a third traversal of object graph 708 by traversing the reference 711 to event object 714, and the program thread compares event object 710 to event object 714. Based on this comparison, the program thread discerns event object 714 is not event object 710. Furthermore, the program thread checks event object 714 for any traversal records that indicate if event object 710 precedes event object 714 in object graph 708. As noted above, the program thread previously cached, within event object 714, a traversal record of the first traversal of object graph 708, and this traversal record indicates event object 710 is included within object graph 708 before event object 714. Accordingly, the program thread may assume that manipulating shared object 702 during the second attempt to complete the program task is causally consistent with the last mutation event of shared object 702 (i.e., the event corresponding to event object 710). This conclusion marks the end of the third traversal of object graph 708 and the third concurrency check on shared object 702.

In an example embodiment, the program thread, acting pursuant to a barrier, initiates a fourth concurrency check on shared object 704 by traversing the reference 705 that originates from shared object 704 and that points to event object 706. This barrier directs the program thread to perform the fourth concurrency check on shared object 704 because completing the program task entails manipulating shared object 704. As noted above, the field holding reference 705 tracks the last mutation event of shared object 704. By traversing this reference 705 to event object 706, the program thread ascertains the event corresponding to event object 706 remains the last event to mutate shared object 704. Note that the program thread was not permitted to manipulate shared object 704 during the first attempt to complete the program task, and the program thread has not yet been permitted to manipulate shared object 704 during the second attempt to complete the program task.

In an example embodiment, the program thread, acting pursuant to a barrier, begins a fourth traversal of object graph 708 by traversing the reference 711 to event object 714, and the program thread compares event object 706 to event object 714. Based on this comparison, the program thread discerns that event object 714 is not event object 706. In addition to the foregoing comparison, the program thread checks for pertinent traversal records cached to event object 714. In particular, the program thread checks for any traversal records that indicate if event object 706 precedes event object 714 in object graph 708. For the purposes of this example, assume that no such traversal record is cached to event object 714. Accordingly, the program thread will proceed onward with the traversal of object graph 708.

In an example embodiment, the program thread, acting pursuant to a barrier, traverses the reference 713 that originates from event object 714 and that points to event object 706, and the program thread confirms the presence of event object 706 in object graph 708 upon traversing this reference 713. In particular, the program thread confirms event object 706 is present in object graph 708 before event object 714 (i.e., the event object corresponding to the second attempt to complete the program task). Accordingly, the program thread may assume that manipulating shared object 704 during the second attempt to complete the program task is causally consistent with the last mutation event of shared object 704. The program thread's conclusion that event object 706 is present in object graph 708 before event object 714 marks the end of the fourth traversal of object graph 708 and the fourth concurrency check on shared object 704. For the purposes of this example, assume there are no other shared objects that will be manipulated while completing the program task, and further assume the second attempt to complete the program task will therefore be successful. Note that in other examples, the program thread may traverse the chain of references in object graph 708 leading to event object 712 and event object 710 before the program thread traverses the reference 713 leading to event object 706. In general, the order that divergent chains of references in an object graph are traversed will vary depending on the type of traversal performed and the traversal algorithm employed for this traversal. Furthermore, as noted above, object graph 708 may be a linear object graph in other examples. For the purposes of this example, assume that the program thread will mutate both shared object 702 and shared object 704 during the second attempt to complete the program task.

In an example embodiment, the program thread, acting pursuant to at least one barrier, remaps reference 703 and reference 705. As noted above, the field holding reference 703 tracks the last mutation event of shared object 702, and the field holding reference 705 tracks the last mutation event of shared object 704. In this example, the program thread mutates both shared object 702 and shared object 704 during the second attempt to complete the program task. Accordingly, the program thread remaps both of these references to point to the event object that represents the second attempt to complete the program task (i.e., event object 714). The program thread remaps these references while executing a single barrier, or the program thread remaps these references while executing two separate barriers that respectively correspond to the separate mutations of these shared objects. The state of heap 701 following the foregoing operations is illustrated in FIG. 7C.

### 6. PRACTICAL APPLICATIONS, ADVANTAGES, AND IMPROVEMENTS

One or more embodiments prevent concurrency issues in a concurrent computing environment by using an object graph of event objects to detect manifestations of a causality bug before a concurrency issue occurs. For instance, based on traversing an object graph of event objects, the system can determine if a task attempting to access shared information risks creating a concurrency issue by conflicting with some other concurrent access to that shared information. If the system determines that completing a task does risk creating a concurrency issue, the system can prevent or delay the completion of the task. By preventing or delaying the completion of a task attempting to access shared information, the system can avoid a scenario where this task is being performed in a concurrent time frame with some other task accessing the same shared information. In this way, the system can avoid conflicting accesses that might otherwise spawn concurrency issues. This allows the system to compensate for deficiencies in a program instance that are resulting in these attempts to perform conflicting accesses to shared information.

One or more embodiments simplify detecting and diagnosing potential concurrency issues and/or causality bugs by maintaining an object graph of event objects that tracks a happens-before ordering of events. By tracking a happens-before ordering of events using an object graph of event objects, the system eliminates complexities in diagnosing concurrency issues that result from differences between the implicit memory ordering of different underlying hardware platforms supporting a concurrent computing environment, such as one that includes threads and runtime memory. As an example, consider one event that is causally dependent from another event. In this example, the other event may not occur in time, in whole or in part, before the one event due to the complexities of an underlying hardware platform. This type of discrepancy between causality and temporal sequence can complicate diagnosing a causality bug based purely on the temporal sequence of events. By tracking a happens-before ordering of events using an object graph of event objects, the system eliminates said complexity from the analysis because the ordering of event objects will reflect the causal relationships between the corresponding events even where the causal ordering of the events does not coincide with the temporal sequence of the events.

One or more embodiments simplify detecting and diagnosing potential concurrency issues and/or causality bugs in a concurrent computing environment by detecting manifestations of a causality bug that do not necessarily result in a concurrency issue. For instance, a causality bug in a program instance may result in causally inconsistent accesses to shared objects; however, not all of these causally inconsistent accesses may result in a concurrency issue. As a result, the concurrency issues that are spawned by the causality bug may appear infrequently and seemingly at random during program execution. The sporadic appearances of concurrency issues that result from a causality bug can make it difficult and time consuming to diagnose and resolve that causality bug. However, based on an object graph of event objects, the system can identify causally inconsistent accesses even if these causally inconsistent accesses do not cause a concurrency issue. By identifying causally inconsistent accesses even when there is no concurrency issue, the system may greatly simplify diagnosing and resolving a concurrency bug.

One or more embodiments reduce the cost of detecting potential concurrency issues and/or causality bugs using an object graph of event objects by configuring the object graph to track a partial ordering of events. For instance, threads in a concurrent computing environment may experience separate events, and these threads may rapidly transition to new events; as runtime continues, the memory resources that are occupied by the corresponding event objects may become non-trivial. Furthermore, the larger an object graph of event objects grows, the more processing resources that are required to fully traverse the object graph while checking for potential concurrency issues. If left unchecked during runtime, these ever growing expenses may render it impractical to check for potential concurrency issues using an object graph of event objects in some applications. However, configuring an object graph of event objects to track a partial ordering of events reduces the size and complexity of the object graph. In this way, the system reduces the memory resources needed to store an object graph of event objects, and the system reduces the processing resources needed to traverse an object graph of event objects.

One or more embodiments reduce the cost of detecting potential concurrency issues and/or causality bugs using an object graph of event objects by generating traversal records that record the outcomes of traversals of the object graph. Caching the result of an earlier traversal of an object graph may shorten the length of a later traversal of the object graph. As an example, consider a traversal of an object graph of event objects seeking to confirm the presence of a particular event object in the object graph, and assume the particular event object is, in fact, present somewhere in the object graph. Instead of traversing the object graph until arriving at the memory location of the particular event object, a thread may cease this traversal upon arriving at the memory location of a subsequent (i.e., more recent) event object in the object graph that caches the result of an earlier traversal that also sought this particular event object. Since the thread is able to confirm the presence of the particular event object based on the prior traversal in this example, the thread does not need to repeat work already performed during the earlier traversal. As a result, the cost of performing the subsequent traversal is reduced in this example. Generally, the cost of traversing an object graph of event objects may be expected to increase over time as the number of event objects in the object graph increases. However, by compelling threads to cache the results of traversals, the system causes the ever growing cost of traversals to increase in an exponentially inverse manner. For instance, the growing cost of performing traversals may be modeled by an inverse Ackermann function time complexity. In other words, by compelling threads to cache the results of traversals, the system effectively caps the rising cost of performing traversals of an object graph of event objects to an essentially constant value.

One or more embodiments reduce the cost of detecting potential concurrency issues and/or causality bugs using an object graph of event objects by removing event objects from the object graph no longer needed to detect potential concurrency issues and/or causality bugs. For instance, caching the result of a traversal that confirmed the presence of an event object in an object graph may eliminate the need to maintain that event object in the object graph. Furthermore, if an event object is no longer a last manipulation object, this event object may no longer be relevant to detecting potential concurrency issues and/or causality bugs. Based on the foregoing principles, the system performs garbage collection tasks that remove excess event objects from an object graph of event objects, thereby reducing the size and complexity of the object graph. In this way, the system reduces the memory resources needed to store an object graph of event objects, and the system reduces the processing resources needed to traverse an object graph of event objects.

### 7. HARDWARE OVERVIEW

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

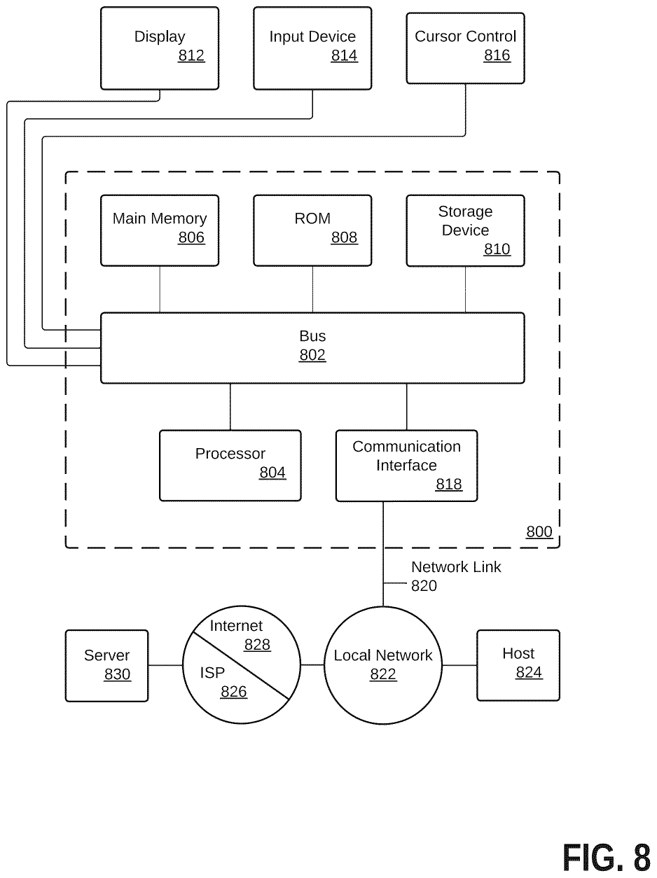

For example, FIG. 8 is a block diagram that illustrates a computer system 800 upon which an embodiment of this disclosure may be implemented. Computer system 800 includes a bus 802 or other communication mechanism for communicating information, and a hardware processor 804 coupled with bus 802 for processing information. Hardware processor 804 may be, for example, a general purpose microprocessor.

Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Such instructions, when stored in non-transitory storage media accessible to processor 804, render computer system 800 into a special-purpose machine that is customized to perform the operations specified in the instructions.

Computer system 800 further includes a read-only memory (ROM) 808 or other static storage device coupled to bus 802 for storing static information and instructions for processor 804. A storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

Computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor 804 executing one or more sequences of one or more instructions included in main memory 806. Such instructions may be read into main memory 806 from another storage medium, such as storage device 810. Execution of the sequences of instructions included in main memory 806 causes processor 804 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 810. Volatile media includes dynamic memory, such as main memory 806. Common forms of storage media include, for example, a floppy disk, a flexible disk, hard disk, solid-state drive (SSD), magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 802. Transmission media can also take the form of acoustic or light waves, such as those generated during radio-wave and infra-red data communications.

Various forms of media may be involved in carrying one or more sequences of one or more instructions to processor 804 for execution. For example, the instructions may initially be carried on a magnetic disk or SSD of a remote computer. The remote computer can load the instructions into its dynamic memory and send the instructions over a telephone line using a modem. A modem local to computer system 800 can receive the data on the telephone line and use an infra-red transmitter to convert the data to an infra-red signal. An infra-red detector can receive the data carried in the infra-red signal and appropriate circuitry can place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card, cable modem, satellite modem, or a modem to provide a data communication connection to a corresponding type of telephone line. As another example, communication interface 818 may be a local area network (LAN) card to provide a data communication connection to a compatible LAN. Wireless links may also be implemented. In any such implementation, communication interface 818 sends and receives electrical, electromagnetic or optical signals that carry digital data streams representing various types of information.

Network link 820 typically provides data communication through one or more networks to other data devices. For example, network link 820 may provide a connection through local network 822 to a host computer 824 or to data equipment operated by an Internet Service Provider (ISP) 826. ISP 826 in turn provides data communication services through the world wide packet data communication network now commonly referred to as the “Internet” 828. Local network 822 and Internet 828 both use electrical, electromagnetic or optical signals that carry digital data streams. The signals through the various networks and the signals on network link 820 and through communication interface 818, which carry the digital data to and from computer system 800, are example forms of transmission media.

Computer system 800 can send messages and receive data, including program code, through the network(s), network link 820 and communication interface 818. In the Internet example, a server 830 might transmit a requested code for an application program through Internet 828, ISP 826, local network 822 and communication interface 818.

The received code may be executed by processor 804 as it is received, and/or stored in storage device 810, or other non-volatile storage for later execution.

### 8. MISCELLANEOUS; EXTENSIONS

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected, and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer-readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer-readable media comprising instructions that, when executed by one or more hardware processors, cause performance of operations comprising:
responsive to a request that instructs a thread to access a shared object while performing a task, identifying a first event object representing a first event that accessed the shared object;
identifying a second event object representing a second event observed by the thread;
based, at least in part, on traversing a chain of one or more references between event objects in an object graph of event objects, determining that (a) the first event object is present in the object graph of event objects or (b) the first event object is not present in the object graph of the event objects; and
performing one of:
(a) if the first event object is present in the object graph of the event objects, permitting the thread to access the shared object with the request, or
(b) if the first event object is not present in the object graph of the event objects, preventing or delaying the thread from accessing the shared object in accordance with the request.

2. The one or more non-transitory computer-readable media of claim 1:
wherein the shared object was created and/or modified during the first event;
wherein the second event corresponds to a current attempt by the thread to complete the task;
wherein the shared object is accessible to a plurality of threads comprising the thread; and
wherein the chain of one or more references between event objects in the object graph of event objects corresponds to a happens-before ordering of events.

3. The one or more non-transitory computer-readable media of claim 1:
wherein determining that the first event object is present in the object graph of event objects comprises determining that the first event object is present in the object graph of event objects before the second event object;
wherein determining that the first event object is not present in the object graph of event objects comprises determining that the first event object is not present in the object graph of event objects before the second event object;
wherein the first event is a last event to create and/or modify the shared object; and
wherein the chain of one or more references between event objects in the object graph of event objects corresponds to a partial ordering of events.

4. The one or more non-transitory computer-readable media of claim 1, wherein the operations further comprise:
responsive to determining that the first event object is not present in the object graph of event objects, adding the first event object to the object graph of event objects at least by storing, in the first event object, a reference to an event object in the object graph of event objects.

5. The one or more non-transitory computer-readable media of claim 1:
wherein determining that the first event object is present in the object graph of event objects comprises identifying a cached result of a prior traversal of the object graph of event objects, the cached result indicating that the first event object is present in the object graph of event objects before a third event object; and
wherein the third event object is present in the object graph of event objects before the first event object.

6. The one or more non-transitory computer-readable media of claim 1, wherein the operations further comprise:
subsequent to determining that the first event object is present in the object graph of event objects:
storing, within the second event object, a record of traversing the chain of one or more references between event objects in the object graph of event objects, the record indicating that the first event object is present in the object graph of event objects.

7. The one or more non-transitory computer-readable media of claim 1:
wherein the shared object comprises a first reference to the first event object representing the first event that accessed the shared object;
wherein identifying the first event object representing the first event that accessed the shared object is based on traversing the first reference from the shared object to the first event object;
wherein a thread-local storage mechanism of the thread comprises a second reference to the second event object representing the second event observed by the thread;
wherein identifying the second event object representing the second event observed by the thread is based on traversing the second reference from the thread-local storage mechanism of the thread to the second event object; and
wherein the second event object comprises a third reference to a third event object in the object graph of event objects.

8. The one or more non-transitory computer-readable media of claim 1, wherein traversing the chain of one or more references between event objects in the object graph of event objects comprises:
traversing a third reference that points to a third event object that is present in the object graph of event objects before the second event object; and
subsequent to traversing the third reference, determining (a) that the third event object is the first event object or (b) that the third event object is not the first event object.

9. The one or more non-transitory computer-readable media of claim 8, wherein determining that the first event object is present in the object graph of event objects is based on determining that the third event object is the first event object.

10. The one or more non-transitory computer-readable media of claim 8, wherein traversing the chain of one or more references between event objects in the object graph of event objects further comprises:
responsive to determining that the third event object is not the first event object:
determining that (a) the third event object comprises a cached result of a prior traversal indicating that the first event object is present in the object graph of event objects before the third event object or (b) the third event object does not comprise the cached result of the prior traversal indicating that the first event object is present in the object graph of event objects before the third event object; and
performing one of:
(a) if the third event object comprises the cached result of a prior traversal indicating that the first event object is present in the object graph of event objects before the third event object, determining that the first event object precedes the second event object in the object graph of event objects; or
(b) if the third event object does not comprise the cached result of the prior traversal indicating that the first event object is present in the object graph of event objects before the third event object, traversing a fourth reference that (a) originates from the third event object and (b) points to a fourth event object that is present in the object graph of event objects before the third event object.

11. A method comprising:
responsive to a request that instructs a thread to access a shared object while performing a task, identifying a first event object representing a first event that accessed the shared object;
identifying a second event object representing a second event observed by the thread;
based, at least in part, on traversing a chain of one or more references between event objects in an object graph of event objects, determining that (a) the first event object is present in the object graph of event objects or (b) the first event object is not present in the object graph of the event objects; and
performing one of:
(a) if the first event object is present in the object graph of the event objects, permitting the thread to access the shared object with the request, or
(b) if the first event object is not present in the object graph of the event objects, preventing or delaying the thread from accessing the shared object in accordance with the request,
wherein the method is performed by at least one device including a hardware processor.

12. The method of claim 11:
wherein the shared object was created and/or modified during the first event;
wherein the second event corresponds to a current attempt by the thread to complete the task;
wherein the shared object is accessible to a plurality of threads comprising the thread; and
wherein the chain of one or more references between event objects in the object graph of event objects corresponds to a happens-before ordering of events.

13. The method of claim 11:
wherein determining that the first event object is present in the object graph of event objects comprises determining that the first event object is present in the object graph of event objects before the second event object;
wherein determining that the first event object is not present in the object graph of event objects comprises determining that the first event object is not present in the object graph of event objects before the second event object;
wherein the first event is a last event to create and/or modify the shared object; and
wherein the chain of one or more references between event objects in the object graph of event objects corresponds to a partial ordering of events.

14. The method of claim 11, further comprising:
responsive to determining that the first event object is not present in the object graph of event objects, adding the first event object to the object graph of event objects at least by storing, in the first event object, a reference to an event object in the object graph of event objects.

15. The method of claim 11:
wherein determining that the first event object is present in the object graph of event objects comprises identifying a cached result of a prior traversal of the object graph of event objects, the cached result indicating that the first event object is present in the object graph of event objects before a third event object; and
wherein the third event object is present in the object graph of event objects before the first event object.

16. The method of claim 11, further comprising:
subsequent to determining that the first event object is present in the object graph of event objects:
storing, within the second event object, a record of traversing the chain of one or more references between event objects in the object graph of event objects, the record indicating that the first event object is present in the object graph of event objects.

17. The method of claim 11:
wherein the shared object comprises a first reference to the first event object representing the first event that accessed the shared object;
wherein identifying the first event object representing the first event that accessed the shared object is based on traversing the first reference from the shared object to the first event object;
wherein a thread-local storage mechanism of the thread comprises a second reference to the second event object representing the second event observed by the thread;
wherein identifying the second event object representing the second event observed by the thread is based on traversing the second reference from the thread-local storage mechanism of the thread to the second event object; and
wherein the second event object comprises a third reference to a third event object in the object graph of event objects.

18. The method of claim 11, wherein traversing the chain of one or more references between event objects in the object graph of event objects comprises:
traversing a third reference that points to a third event object that is present in the object graph of event objects before the second event object; and
subsequent to traversing the third reference, determining (a) that the third event object is the first event object or (b) that the third event object is not the first event object.

19. The method of claim 18, wherein determining that the first event object is present in the object graph of event objects is based on determining that the third event object is the first event object.

20. A system comprising:
one or more hardware processors;
one or more non-transitory computer-readable media; and
program instructions stored on the one or more non-transitory computer-readable media that, when executed by the one or more hardware processors, cause the system to perform operations comprising:
responsive to a request that instructs a thread to access a shared object while performing a task, identifying a first event object representing a first event that accessed the shared object;
identifying a second event object representing a second event observed by the thread;
based, at least in part, on traversing a chain of one or more references between event objects in an object graph of event objects, determining that (a) the first event object is present in the object graph of event objects or (b) the first event object is not present in the object graph of the event objects; and
performing one of:
(a) if the first event object is present in the object graph of the event objects, permitting the thread to access the shared object with the request, or
(b) if the first event object is not present in the object graph of the event objects, preventing or delaying the thread from accessing the shared object in accordance with the request.
